(19) United States
(12) Patent Application Publication
(10) Pub. No.: US 2019/0243809 A1
(43) Pub. Date: Aug. 8, 2019

(54) VISUAL FILE SYSTEM

(71) Applicant: ROOMFUL CO, Suffem, NY (US)

(72) Inventor: Alex Avraham Shtaygrud, Suffern, NY (US)

(21) Appl. No.: 16/339,679

(22) PCT Filed: Oct. 5, 2017
(86) PCT No.: PCT/US17/55362

§ 371 Date: Apr. 4, 2019

Related U.S. Application Data
(60) Provisional application No. 62/404,527, filed on Oct. 5, 2016.
(60) Provisional application No. 62/438,691, filed on Dec. 23, 2016.
(60) Provisional application No. 62/469,328, filed on Mar. 9, 2017.

(51) Int. Cl. G06F 16/188; G06F 16/16; G06F 9/451; G06F 16/13

(52) U.S. Cl. CPC G06F 16/192; G06F 16/168; G06F 3/0484; G06F 16/162; G06F 16/13; G06F 9/451

(57) ABSTRACT

Aspects of the present disclosure relate to managing digital content with a visual file interface. As an example, one or more processing devices 110-140 may generate a virtual environment in a graphical user interface that comprises one or more rooms, each room including one or more room components therein. The one or more processing devices 110-140 may receive, from a user device 120-140, a request to associate a digital file with a selected one of the one or more room components and create the association between the digital file and the selected room component. The digital file may be retrieved and stored in association with the one or more room components.

### CROSS REFERENCE TO RELATED APPLICATIONS

The present application claims the benefit of the filing date of U.S. Provisional Patent Application No. 62/469,328 filed on Mar. 9, 2017; U.S. Provisional Application No. 62/438,691 filed on Dec. 23, 2016; and U.S. Provisional Application No. 62/404,527 filed Oct. 5, 2016; the disclosures of which are hereby incorporated hereby by reference.

### BACKGROUND

Computer file systems are generally hierarchical in nature. Files may be stored within folders, and each folder may be stored within other folders, so that each folder forms part of a hierarchical level. The number of hierarchical levels within a file system can be unlimited. Finding particular files and folders within a hierarchical file system can be difficult, such as when files and folders are arbitrarily named and users need to navigate through a number of hierarchical levels before finding a particular file or folder. For those who do not have much experience with file systems or may not be tech savvy (e.g., children and the elderly), hierarchical systems may be unintuitive and difficult to understand. As such, users may be unable to find the file for which they are searching.

To enable a user to navigate through a hierarchical file system, naming conventions and standards are often implemented. Such naming conventions include a set of rules users must follow when naming files and folders within the hierarchical file system. However, these naming conventions and systems are often ignored and incorrectly applied, resulting in folders and files being incorrectly labeled. Finding mislabeled files and folders can be difficult, especially in larger file systems. Further, such naming conventions and systems can be incomprehensible to an untrained user. As such, users of hierarchical file systems often need to learn the naming conventions and systems before being able to efficiently navigate the hierarchical file system to find a particular file.

In addition to folder and file naming inconsistencies, subjective folder organization also makes it difficult to navigate through the levels of the hierarchical file system. Many times users indiscriminately create and store folders, such as in default locations defined by the file system. Similarly, users often store files in the first folder which they are presented. As such, folders may become catchalls storing unrelated files, and the folders themselves may be arbitrarily located within the hierarchy.

In collaborative environments, multiple users may manage files and folders within a hierarchical file system. Each user may have personal preferences and habits for organizing a file system. The preferences and habits of each user may carry over to the naming of the folders and files in the hierarchical file system. As such, the names of the files and folders may lack cohesion, especially in collaborative environments with large numbers of users. Thus, even users who operate in the collaborative environment regularly may struggle to navigate the file system when confronted with finding a file or folder named by another user.

Attempts have been made to make the navigation of files and folders easier. For example, some systems present user interfaces which allow users to organize and display files alphabetically, by file type, by creation date, etc. Nevertheless, those organizations are unnatural for most users; as such users may not typically retrieve or store information in those ways. Accordingly, users struggle to quickly find the files which they desire. Additionally, multiple instances of a file system's interface may be needed to move and copy files from one folder to another folder, which can be confusing to users.

Social networks provide outlets for users to share content such as ideas, news, and other such information. Generally, a user of a social network connects with other users on the network to develop a collection of followers. The user may then share content to their followers. However, their followers may include acquaintances, family, friends, and strangers. For personal or private content the user may not want to share such content with all of their followers.

To target content to particular followers, a user may separate their followers into groups, such as a group containing the user's friends, a group containing the user's family, and a group containing all of their followers. By placing followers into groups a user may control which followers will see a particular piece of content. Grouping followers may become tedious and time consuming when a user wants to share content with only particular members of certain groups. For example, a user may want to share a holiday picture containing friends and family members, with those friends and family members in the picture. The user can share the holiday picture with the friends and family group, but those groups may also contain family and friends not in the picture. As such, the user may need to create a separate sub-grouping for only the friends and family in the picture. Depending on the number of pictures the user wants to share, and the followers within those pictures, the user may need to create a large number of sub-groupings.

While the user may share some or all of their content with all of their followers, many followers of the user may become irritated by being provided content for which they have no interest. For instance, a user may follow a musician to learn about the musician's music and upcoming shows. The musician may provide music and show update content to all of their followers, but also political musings and social stances for which the follower has no interest. As such, the user has to endure the musician's political musings and social stances to find out about the musician's music and shows.

Content posted by a user typically ends up on a user's timeline. As users post more content over days, months, and years, the ability to find past content becomes increasingly difficult. In this regard, the content posted by the user is organized in an unintuitive manner, as all of their content, including pictures, multimedia, and comments, are stored together on a timeline. A follower, and even the user, may need to scour through hundreds, thousands, or more postings of content on a user's timeline to find what they are searching for. As such, much of the content posted by a user is fleeting in nature. In this regard, after the initial posting and viewing of the content, the user and their followers may never go back to the content again. Furthermore, for content, such as a collection of pictures captured in the past, the user's timeline may arrange those pictures on the day they are posted, as opposed to when they were captured. Accordingly, the user's timeline is not an accurate depiction of the user's legacy.

Three-dimensional virtual and augmented reality hardware systems have begun to move into the mainstream. Accordingly, demand for virtual reality environments will increase as users adapt to the virtual reality technology. However, the software currently available to create virtual reality environments is difficult to learn and unintuitive to operate. Thus, only individuals with significant training are able to easily develop immersive virtual reality environments and untrained individuals, who may have a desire to create virtual environments, are unable to develop their visions without significant effort. As such, the creation of virtual reality environments is hampered by technological barriers resulting in viewer available virtual reality environments for users.

### SUMMARY

Embodiments within the disclosure relate generally to providing a virtual visual file system environment for storing, moving, copying, sharing, and accessing digital content within digital storage. One aspect includes a method for managing digital content with a visual file interface. One or more processing device may generate a virtual environment in a graphical user interface that comprises one or more rooms, each room including one or more room components therein. The one or more processing devices may receive from a user device a request to associate a digital file with a selected one of the one or more room components and create the association between the digital file and the selected room component. The digital file may be retrieve and stored by the one or more processing devices in association with the one or more room components.

In some embodiments, a request to view the digital file may be received from a user device and in response to the request to view the digital file, the digital file may be transmitted to the user device.

In some embodiments, the one of the one or more room components include one or more structures and/or one or more objects.

In some embodiments, the digital file is retrieved from a website or from the user device.

In some embodiments, the one or more room components are each selected from the group consisting of a piece of furniture, a bookcase, a file cabinet, a picture frame, entertainment element, and a piece of artwork.

In some embodiments, the virtual environment represents a house and the one or more rooms are located on floors within the house.

In some embodiments, the digital file is stored in a storage device remotely located from the user device.

In some embodiments a request to delete the association of the digital file may be received from a user device and in response to the request to delete the digital file, the digital file from may be deleted from the storage device.

In some embodiments the digital file is stored in association with the one or more room components, an indicator is provided which shows the one or more room components contain the digital file.

In some embodiments the digital file is a three-dimensional model, a three-dimensional animation, or a three-dimensional game.

Another aspect includes a system for managing digital content with a visual file interface. The system may include one or more computing devices and memory storing instructions, the instructions executable by the one or more computing devices. The instructions may include generating a virtual environment in a graphical user interface that comprises one or more rooms, each room including one or more room components therein; receiving from a user device, a request to associate a digital file with a selected one of the one or more room components; creating the association between the digital file and the selected room component; retrieving the digital file; and storing, by the one or more processing devices, the digital file in association with the one or more room components.

Another aspect includes a non-transitory computer-readable medium storing instructions. The instructions, when executed by one or more processors, may cause the one or more processors to perform the steps of: generating a virtual environment in a graphical user interface that comprises one or more rooms, each room including one or more room components therein; receiving from a user device, a request to associate a digital file with a selected one of the one or more room components; creating the association between the digital file and the selected room component; retrieving the digital file; and storing, by the one or more processing devices, the digital file in association with the one or more room components.

Some aspects within the disclosure relate generally to providing a virtual visual file system environment for storing, moving, copying, sharing, and accessing digital content within digital storage. One aspect includes a method for sharing digital content with a virtual sharing interface. The method includes receiving, by one or more processing devices, one or more access controls, the one or more access controls including a follower selection. The one or more processing devices receive a selection of a virtual environment and generate an invitation to access the selected virtual environment based on the one or more access controls. The invitation is transmitted to a follower indicated by the follower selection.

In some embodiments the one or more access controls further comprises a level of interactivity, wherein the level of interactivity includes one or more of ownership, contribution permission, editing permission, and viewing permission.

In some embodiments the one or more access controls further comprises a time-restriction, the time-restriction limiting the selected follower's access to a particular time period.

In some embodiments the follower selection includes multiple followers and the multiple followers are members of a social network.

In some embodiments the invitation includes a link to the selected virtual environment and an explanation of the one or more access controls.

In some embodiments the virtual environment represents a private environment, a social environment, or an event environment.

Another aspect includes a system for sharing digital content with a virtual sharing interface. The system may include one or more computing devices and memory storing instructions, the instructions executable by the one or more computing devices. The instructions may include receiving one or more access controls, the one or more access controls including a follower selection; receiving a selection of a virtual environment and generating an invitation to access the selected virtual environment based on the one or more access controls; and transmitting the invitation to a follower indicated by the follower selection.

Another aspect includes a non-transitory computer-readable medium storing instructions. The instructions, when executed by one or more processors, may cause the one or more processors to perform the steps of: receiving one or more access controls, the one or more access controls including a follower selection; receiving a selection of a virtual environment and generating an invitation to access the selected virtual environment based on the one or more access controls; and transmitting the invitation to a follower indicated by the follower selection.

In accordance with some aspects of the technology, systems, apparatuses, and methods provide users with the ability to generate and/or otherwise modify a virtual environment by adding structures, additional rooms, and objects.

Some aspects may include a method for creating virtual environments in a computer system. The method comprises generating, with one or more processing devices of the computer system, a virtual environment in a graphical user interface that comprises one or more virtual rooms, at least a first of the one or more rooms including one or more modifiable locations. The one or more processing devices may receive a first input from a user device, the first input identifying a room structure selection from one or more room structure icons provided by the graphical user interface, and receive a second input from the user device, the second input identifying a first of the one or more modifiable locations. The one or more processing devices may update the virtual environment with a room structure corresponding to the identified room structure selection at the identified first modifiable location.

In some embodiments a request to apply a style to at least one of the one or more rooms may be received from the user device and the style may be applied to the at least one room.

In some embodiments a third input and fourth input from a user device may be received with the one or more processing devices, the third input identifying a room addition option of the graphical user interface and the fourth input identifying a second of the one or more modifiable locations. A room addition corresponding to the identified room addition may be appended onto the identified second modifiable location.

In some embodiments the room structure icons represent room structures compatible with the virtual environment.

In some embodiments the room structure displayed on the graphical user interface includes at least one of wall panel, a window, a light, a floor, or a door.

In some embodiments the one or more room structure icons are presented in the graphical user interface along a bottom section of the virtual environment.

In some embodiments the room addition includes one or more of a living room, a bedroom, an office, a library, a kitchen, an attic, or a basement.

In some embodiments the one or more processing devices may receive from a user device a request to associate a digital file with a selected room structure within the virtual environment; create the association between the digital file and the selected room structure in a database of the computer system; retrieve the digital file; and store the digital file in association with the selected room structure.

In some embodiments the room addition options represent room additions compatible with the virtual environment.

### BRIEF DESCRIPTION OF THE DRAWINGS

The foregoing aspects, features and advantages of the present invention will be further appreciated when considered with reference to the following description of exemplary embodiments and accompanying drawings, wherein like reference numerals represent like elements. In describing the exemplary embodiments of the invention illustrated in the drawings, specific terminology may be used for the sake of clarity. However, the aspects of the invention are not intended to be limited to the specific terms used.

FIG. 1 is a functional diagram of an example system in accordance with aspects of the disclosure.

FIG. 2 is a pictorial diagram of the example system of FIG. 1.

FIG. 3 is an illustration of a registration and login screen in accordance with aspects of the disclosure.

FIG. 4 is an illustration of a mobile login screen in accordance with aspects of the disclosure.

FIG. 5 is an illustration of a home screen for a virtual environment in accordance with aspects of the disclosure.

FIG. 6 is an illustration of a room selection screen in accordance with aspects of the disclosure.

FIGS. 7A and 7B are illustrations of rooms in accordance with aspects of the disclosure.

FIG. 8A is an illustration of an office room in accordance with aspects of the disclosure.

FIG. 8B is an illustration of a file selection interface in accordance with aspects of the disclosure.

FIG. 9 is an illustration of a trashcan in accordance with aspects of the disclosure.

FIG. 10 is an illustration of a book shelf object in accordance with aspects of the disclosure.

FIG. 11 is an illustration of a book collection interface in accordance with aspects of the disclosure.

FIG. 12 is an illustration of a three-dimensional room in accordance with aspects of the disclosure.

FIG. 13 is an illustration of a three-dimensional object in accordance with aspects of the disclosure.

FIG. 14 is an illustration of an invitation creation interface in accordance with aspects of the disclosure.

FIG. 15 is an illustration of an invitation in accordance with aspects of the disclosure.

FIG. 16 is an illustration of a welcome screen in accordance with aspects of the disclosure.

FIG. 17 is an illustration of a room selection screen in accordance with aspects of the disclosure.

FIG. 18 is an illustration of a room construction selection interface in accordance with aspects of the disclosure.

FIG. 19 is an illustration of a room style interface in accordance with aspects of the disclosure.

FIG. 20 is an illustration of a full screen interface in accordance with aspects of the disclosure.

FIG. 21 is an illustration of a contextual menu in accordance with aspects of the disclosure.

FIG. 22 is an illustration of a room constructor interface in accordance with aspects of the disclosure.

FIG. 23 is an illustration of adding a room structure in accordance with aspects of the disclosure.

FIG. 24 is an illustration of an added room structure in accordance with aspects of the disclosure.

FIG. 25 is another illustration of a full screen interface in accordance with aspects of the disclosure.

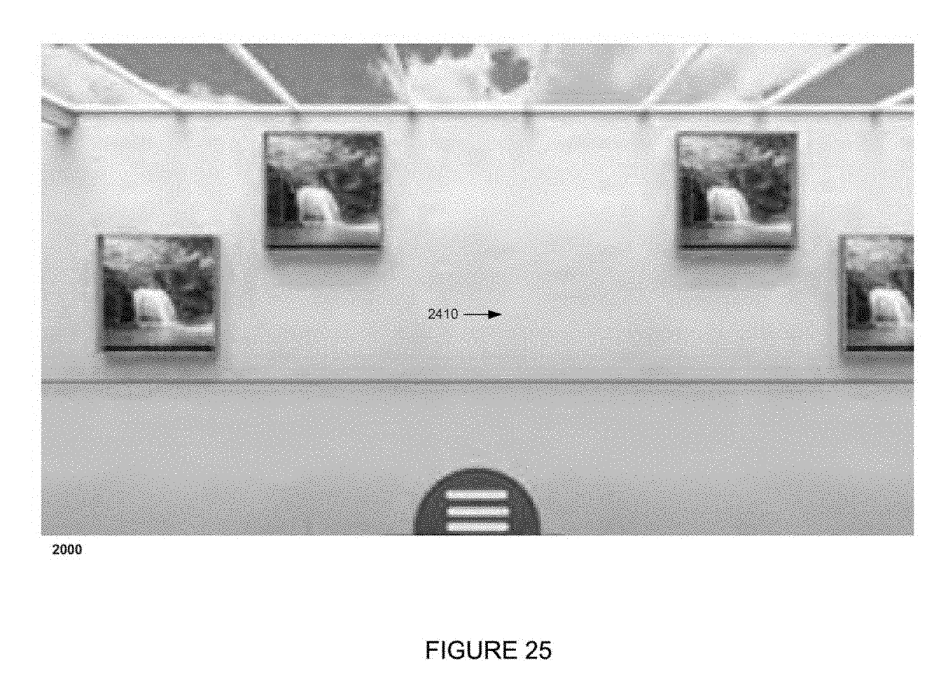

FIG. 26 is another illustration of a room constructor interface in accordance with aspects of the disclosure.

FIG. 27 is another illustration of an added room structure in accordance with aspects of the disclosure.

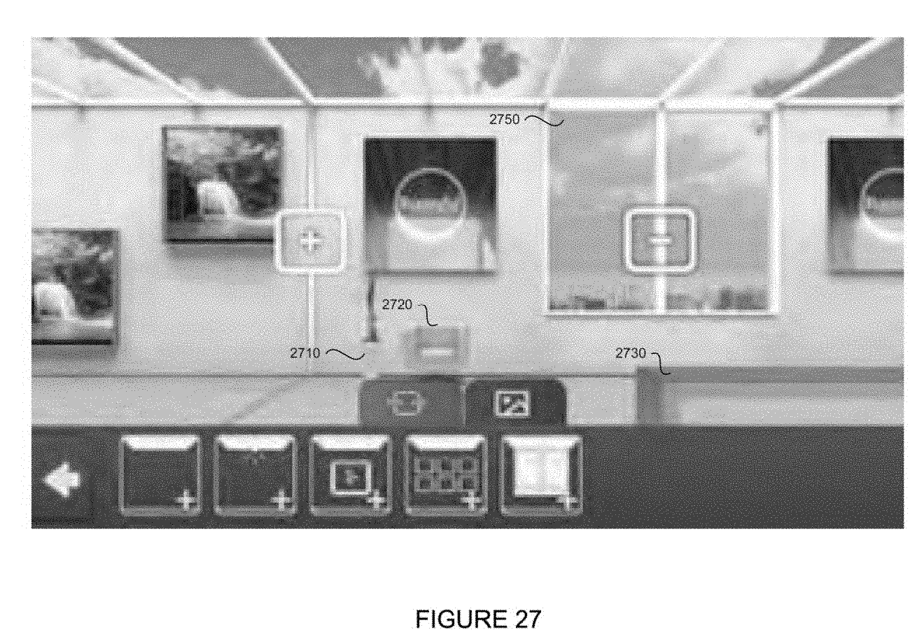

FIG. 28 is an illustration of a room addition interface in accordance with aspects of the disclosure.

FIG. 29 is an illustration of adding a room in accordance with aspects of the disclosure.

FIG. 30 is an illustration of an added room in accordance with aspects of the disclosure.

FIG. 31 is another illustration of adding a room in accordance with aspects of the disclosure.

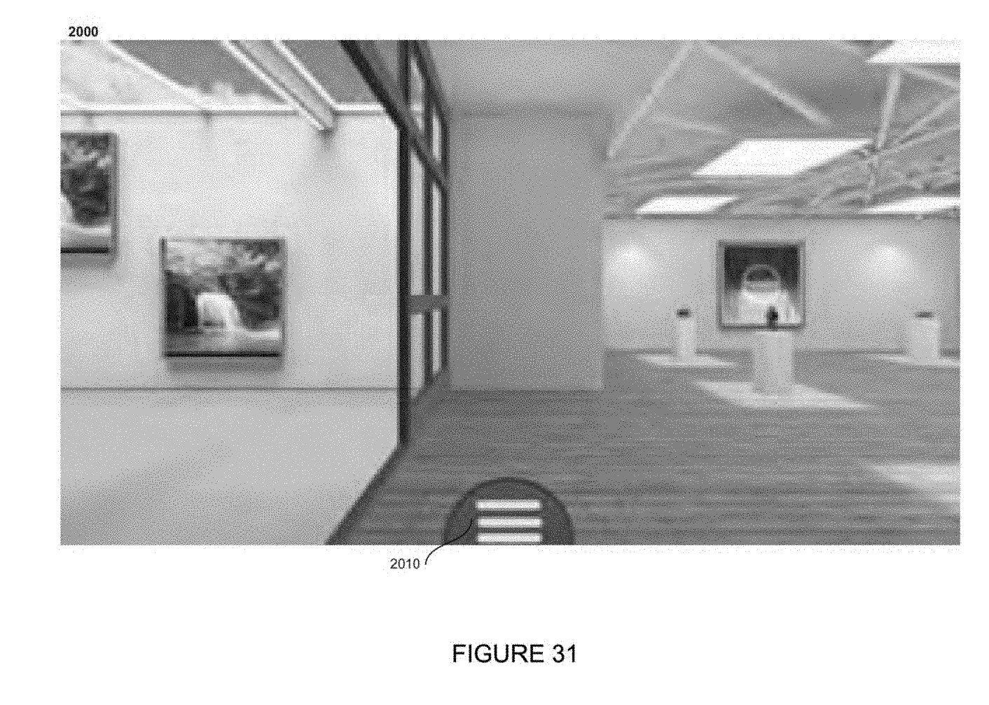

FIG. 32 is another illustration of an added room in accordance with aspects of the disclosure.

FIG. 33 is another illustration of a room interface in accordance with aspects of the disclosure.

FIG. 34 is an illustration of an object addition interface in accordance with aspects of the disclosure.

### DETAILED DESCRIPTION

### Overview

This technology relates to, by way of example, generating and/or otherwise modifying a virtual environment by adding structures and additional rooms within a virtual environment. In this regard, in one scenario a user may generate a default room, comprised of wall panels and various other structures. Upon generating the default room, a user may select one or more preconfigured room styles, which may be applied to the default room.

The user may navigate the room through a full screen interface. The full screen interface allows the user to view all angles of the three-dimensional virtual environment and interact with room components within the virtual environment. The full screen interface may also include a selectable option that, upon activation, may provide contextual menus for further customization of the room and virtual environment.

The contextual menus include a number of options providing access to various interfaces and menus, such as the home menu, a room constructor menu, a room designer interface, a content addition interface, and a settings interface.

The room constructor interface may include at least two types of room constructor modes, for example a room modification mode and a room addition mode. Upon entering the room modification mode, the room constructor interface may provide modifiable locations where structures may be added to the virtual environment. Additionally, the structures which may be added to the modifiable locations may be presented in a structure ribbon as selectable structure icons. To add a structure to the modifiable location, a user may select one of the structure icons and drop the structure upon the modifiable location where the structure is to be added. The room constructor interface is then updated to include the added structure. Structures may also be removed from a room via the interface.

The room addition interface provides modifiable locations where additional rooms may be constructed. In some embodiments rooms may be added only to the beginning or end of an existing room. The rooms which may be added to the modifiable locations may be presented in a room ribbon where each room may be represented by a selectable room icon which represents predefined room styles and configurations.

To add a room to an existing virtual environment, one of the room icons may be selected and dropped upon the modifiable location where the room is to be added. Upon dropping the room icon, the room addition interface is updated to include a new room in the style corresponding to the selected room icon.

Each room may be populated by a file system. In this regard, each room and the structures and objects contained within the rooms may provide an interface for creating a virtual visual file system environment for storing, moving, copying, sharing, and accessing digital content within digital storage. The technology enables a user to create, remove, organize, and otherwise customize a personalized environment, such as a room, in which virtual objects may be placed within a virtual environment constructed of virtual structures. Digital content may be associated with virtual objects or virtual structures within the personalized environment. The user may interact with the virtual objects or virtual structures to retrieve, view, or otherwise manipulate the digital content associated with the respective virtual objects. As such, the technology provides a fundamentally different way to interact with and store digital content within digital storage.

For instance, a user of a computing device may register for access to a virtual file system by navigating to the virtual file system. The user may provide the virtual file system information with requested personal information and the virtual file system may generate a personalized account to which the user may be assigned.

Upon the user logging into their personalized account, the user may access a selection interface which includes one or more virtual visual environments which the user may access. Each virtual environment may be a two-dimensional or three-dimensional visual representation of a house, building, and/or location wherein a user may retrieve, view, or otherwise manipulate digital content. Virtual environments other than these may also be presented to the user. For instance, a virtual environment may include any type of building or location such as a library, a town hall, a subway station, a park, a street, etc.

Upon the user selecting a particular virtual environment, the visual file system provides a room selection interface for display. The room selection interface may include an overview of the rooms contained within the selected environment. Each room may represent one or more containers for storage of digital content.

Each room may be constructed of one or more structures, such as windows, doors, walls, floors, etc. The combination and arrangement of the building structures may determine the size, shape, and layout of the room.

Objects, including any non-structural articles, may also be positioned within a room. In this regard, objects may be added, deleted, and/or rearranged by the user. In some embodiments users may create objects or the objects may be provided by the visual file system.

The user is able to associate digital content with structures and objects in a given room. In this regard, the user may request association of digital content with a particular structure or object by selecting the structure or object. For example, the user may request association of a piece of digital content with an object, and the computing device may upload a copy of the digital content to the visual file system. In one example, the visual file system stores a copy of the piece of digital content in conjunction with data indicating the object(s) or structure(s) with which the digital content is associated. The visual file system may then provide an indicator in the virtual environment that the object or structure now contains the piece of digital content.

Objects and structures may be associated with third party digital content in the file selection interface. In this regard, a user may navigate from within the file selection interface to a third party location, such as a URL address or networked attached storage device, and select a file or dynamic digital content, such as an RSS feed or social media feed. In response to the selection, the visual file system may store the location of the selected third part digital content in association with the selected objects and/or structures, so that the content is accessible to the user via the objects and/or structures in respective room(s) of the visual file system.

A user may access digital content associated with an object or structure. For example, the user may select an object such as a desk or file cabinet in a given room and the virtual file system may provide the digital content associated with the object to the computing device for display. In some embodiments the virtual file system may determine if a local copy of the digital content is available, and if so, instruct the computing device to open the local copy.

A virtual social network may allow users to join and share their virtual environments with other users. The user may create an invitation to one or more of their followers which grants access one or more virtual environments through an invitation creation interface. The user may select which virtual environments to provide access to through a virtual environment selection interface within the invitation creation interface. The one or more virtual environments may include any virtual environment controlled by the user, such as a room, building, village, street, park etc., as well as social environments belonging to a collection of users, such as a village, or virtual environments within the village, such as a store, team room, community room, etc. Moreover, the one or more virtual environments may include event spaces which may represent a common space for users that participate in a certain event, club, or interest.

A user may select which followers to share the one or more virtual environments from a follower selection interface within the invitation creation interface. The follower selection interface may recommend followers based on the one or more virtual environments being shared and the history/interests of the followers.

A user may select levels of interactivity that the selected followers may have with the selected one or more virtual environments, objects within the one or more virtual environments, and the contents associated with the one or more virtual environments and/or objects through an interaction interface. Levels of interactivity may include ownership, contribution permission, editing/moderating permission, and commenting permission. Ownership permission may grant the selected followers co-ownership of the one or more virtual environments.

Selected followers may receive an invitation from the user indicating the locations to which they are being offered access. From the invitation, the follower may select one of the virtual environments from the listing of virtual environments and be taken to the selected virtual environment.

A user may request access to another user's virtual environment for which they would like to view. Upon requesting access the owner of the virtual environment may be provided with a notification that a user has requested access. The owner may then grant or deny the user access to the virtual environment. The owner may provide a level of interactivity and time-restriction on the user. An owner may pre-emptively provide access, level of interactivity, and time-restrictions to one or more virtual environments.

Each virtual environment, including the contents and objects contained therein, may be associated with commentary and feeback. In this regard, users with access to a virtual environment may leave comment and feedback for the owner of the virtual environment and/or other users who visit the virtual environmnent.

Content from the user's other social networks may be aggregated within the virtual social network. In this regard, the virtual social network may automatically create a room in a user's virtual environment based on the detected activity and/or content posted to the other social network(s).

The features described herein may allow for a method and system which provides users with the ability to store, move, copy, share, and access files in an intuitive, cohesive, organized visual file system over a virtual social network. In this regard, users may intuitively organize digital content in a virtual space according to the commonly known organizational structure found within real-world environment. The user may then provide access to the digital content by providing access to the virtual space. As such, users who would be interested in seeing such content may be provided the ability to view it, disinterested users are spared from needing to view the content.

The features described herein may also allow for the creation of unique three-dimensional virtual environments using two-dimensional flat screen computing devices, such as smartphones, desktops, and laptops. Thus, even untrained individuals may easily create virtual environments using readily accessible hardware.

### Example Systems

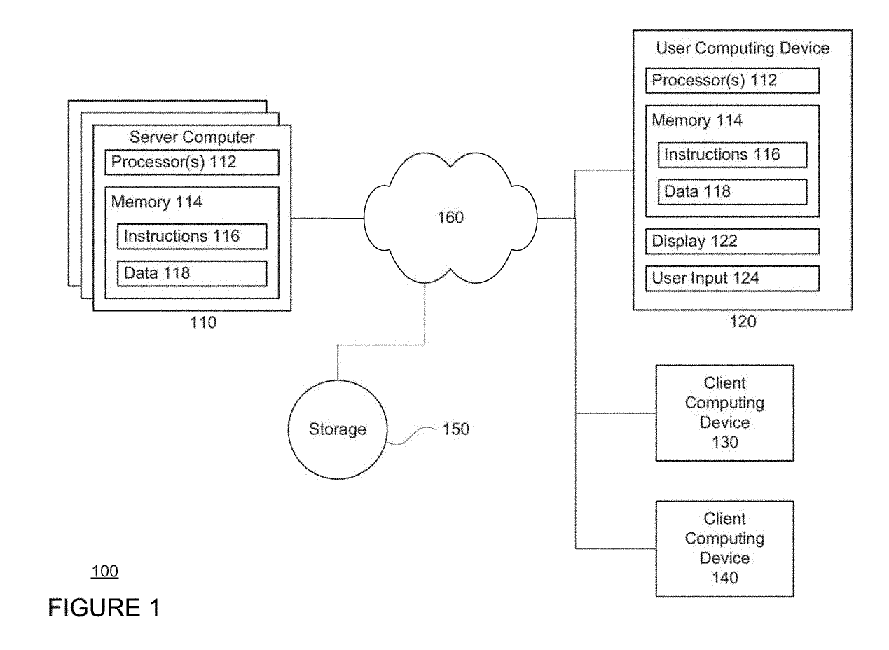

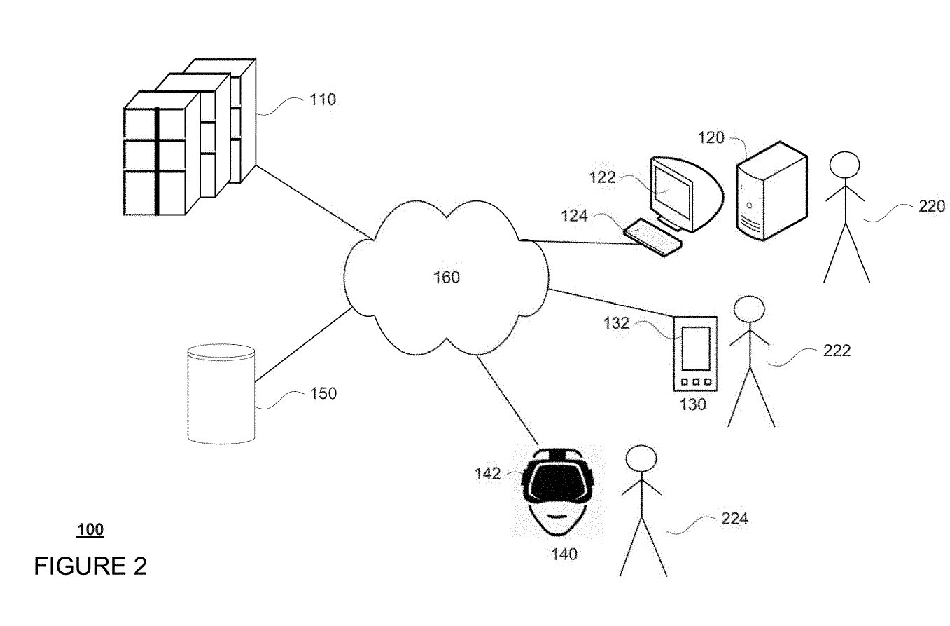

FIGS. 1 and 2 include an example system 100 in which the features described above may be implemented. It should not be considered as limiting the scope of the disclosure or usefulness of the features described herein. In this example, system 100 can include computing devices 110-140 as well as storage system 150. Each computing device 110-140 can contain one or more processors 112, memory 114 and other components typically present in general purpose computing devices. Memory 114 of each of computing devices 110-130 can store information accessible by the one or more processors 112, including instructions 116 that can be executed by the one or more processors 112.

Memory 114 can also include data 118 that can be retrieved, manipulated or stored by the processor. The memory can be of any non-transitory type capable of storing information accessible by the processor, such as a hard-drive, memory card, ROM, RAM, DVD, CD-ROM, write-capable, and read-only memories.

The instructions 116 can be any set of instructions to be executed directly, such as machine code, or indirectly, such as scripts, by the one or more processors. In that regard, the terms “instructions,” “application,” “steps,” and “programs” can be used interchangeably herein. The instructions can be stored in object code format for direct processing by a processor, or in any other computing device language including scripts or collections of independent source code modules that are interpreted on demand or compiled in advance. Functions, methods, and routines of the instructions are explained in more detail below.

Data 118 may be retrieved, stored or modified by the one or more processors 112 in accordance with the instructions 116. For instance, although the subject matter described herein is not limited by any particular data structure, the data can be stored in computer registers, in a relational database as a table having many different fields and records, or XML documents. The data can also be formatted in any computing device-readable format such as, but not limited to, binary values, ASCII or Unicode. Moreover, the data can comprise any information sufficient to identify the relevant information, such as numbers, descriptive text, proprietary codes, pointers, references to data stored in other memories such as at other network locations, or information that is used by a function to calculate the relevant data. Data may include any type of digital content including electronic documents, pictures, videos, 3D models, and other such multimedia, as well as links to such digital content, deep links to another application (i.e., another “app”,) as well as links to other rooms or virtual environments. Data may also include acting scripts which cause the one or more processors to perform a function, such as play multimedia, execute a game, etc.

The one or more processors 112 can be any conventional processors, such as a commercially available CPU. Alternatively, the processors can be dedicated components such as an application specific integrated circuit (“ASIC”), a system on chip (“SOC”), or other hardware-based processor.

Although FIG. 1 functionally illustrates the processor, memory, and other elements of computing devices 110-140 as being within the same block, the processor, computer, computing device, or memory can actually comprise multiple processors, computers, computing devices, or memories that may or may not be stored within the same physical housing. For example, the memory can be a hard drive or other storage media located in housings different from that of the computing devices 110-140. Accordingly, references to a processor, computer, computing device, or memory will be understood to include references to a collection of processors, computers, computing devices, or memories that may or may not operate in parallel. For example, the computing device 110 may include server computing devices operating as a load-balanced server farm, distributed system, etc. Yet further, although some functions described below are indicated as taking place on a single computing device having a single processor, various aspects of the subject matter described herein can be implemented by a plurality of computing devices communicating information over network 160.

Each of the computing devices 110-140 can be at different nodes of a network 160 and capable of directly and indirectly communicating with other nodes of network 160. Although only computing devices 110-140 are depicted in FIGS. 1-2, it should be appreciated that a typical system can include a large number of connected computing devices, with each different computing device being at a different node of the network 160. The network 160 and intervening nodes described herein can be interconnected using various protocols and systems, such that the network can be part of the Internet, World Wide Web, specific intranets, wide area networks, or local networks. The network can utilize standard communications protocols, such as Ethernet, WiFi, HTTP, and UDP protocols that are proprietary to one or more companies, and various combinations of the foregoing. Although certain advantages are obtained when information is transmitted or received as noted above, other aspects of the subject matter described herein are not limited to any particular manner of transmission of information.

As an example, each of the computing devices 110 may include web servers capable of communicating with storage system 150 as well as computing devices 120,130, and 140 via the network. For example, one or more of server computing devices 110 may use network 160 to transmit and present information to a user, such as user 220, 222, or 224, on a display, such as displays 122, 132, and 142 of computing devices 120, 130, and 140, respectively. In this regard, computing devices 120, 130, and 140 may be considered client user computing device and may perform all or some of the features described herein.

Although the user computing device 120 is illustrated as a full-sized personal computing device, user computing device 130 is illustrated as a mobile phone, and user computing device 140 is illustrated as a virtual reality headset each may comprise a full-sized personal computing device or a mobile computing device capable of wirelessly exchanging data with a server over a network such as the Internet. By way of example only, client computing device 120 may be a mobile phone or a device such as a wireless-enabled PDA, a tablet PC, laptop PC, or a netbook that is capable of obtaining information via the Internet. In another example, user computing device 140 may be a head-mounted computing system, a virtual reality system, an augmented reality system, a cardboard virtual reality system including a mobile phone or computer, etc. As an example the user may input information using a small keyboard, a keypad, microphone, using visual signals with a camera, or a touch screen.

As with memory 114, storage system 150 can be of any type of computerized storage capable of storing data and information accessible by the server computing devices 110, such as a hard-drive, memory card, ROM, RAM, DVD, CD-ROM, write-capable, and read-only memories. In addition, storage system 150 may include a distributed storage system where data is stored on a plurality of different storage devices which may be physically located at the same or different geographic locations. Storage system 150 may be connected to the computing devices via the network 160 as shown in FIG. 1 and/or may be directly connected to any of the computing devices 110, 120, 130, and 140.

### Example Methods

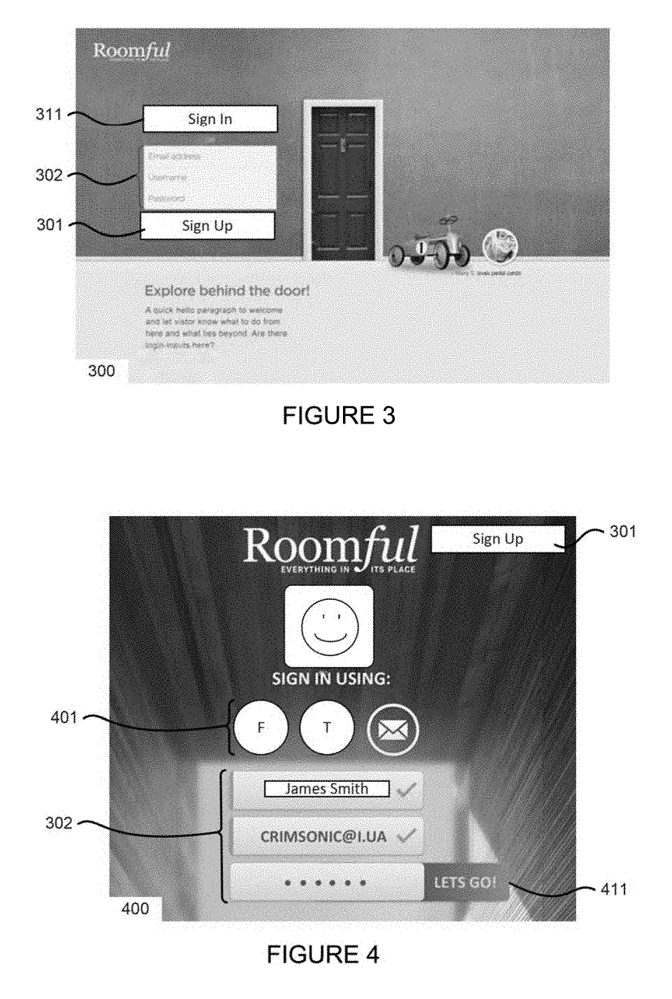

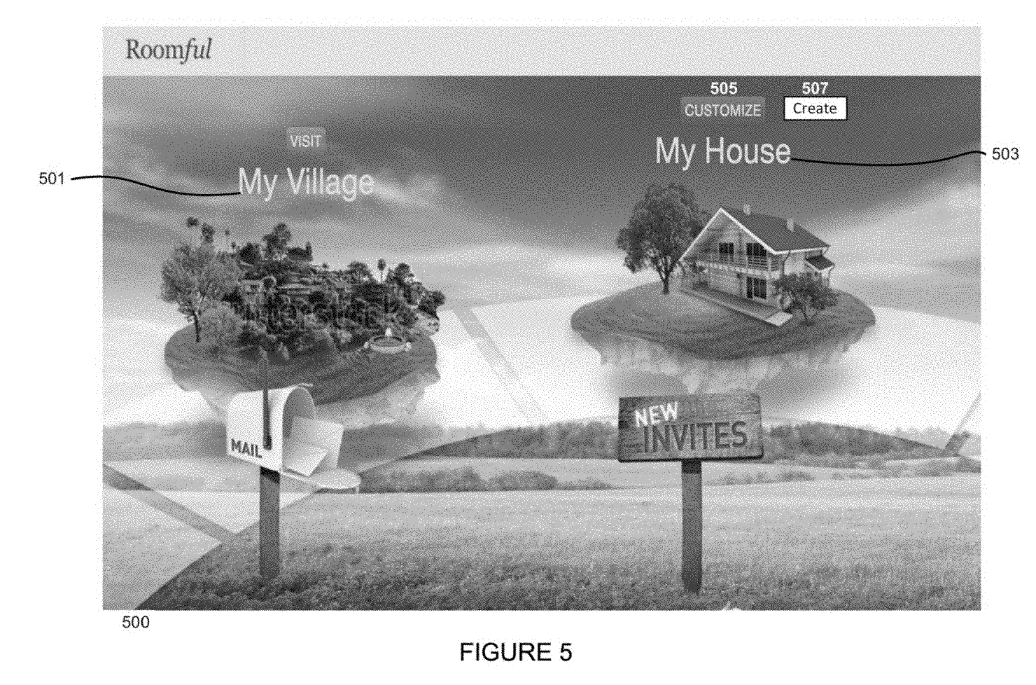

A user of a computing device, such as user computing device 120, may register for access to a visual file system executing on a computing device, such as server computer 110. In this regard, upon the user navigating to the visual file system, such as through a web browser, the server computer 110 may provide for display on computing device 120, a registration page 300, as shown in FIG. 3, or a mobile registration page 400 as shown in FIG. 4. In some embodiments the visual file system will detect the type of computing device (e.g., mobile device or desktop computer,) which is attempting to navigate to the file system and provide the appropriate registration page.

The user may provide the requested personal information (e.g., name, address, age, password, username, an iris scan, fingerprints, and other such identification information). For example, the user may enter their email address, a username, and a password, into input section 302 and then select the “Sign Up” button 301, as further shown in FIGS. 3 and 4. Based upon the provided personal information, the virtual file system may generate a personalized virtual account to which the user may be assigned.

In some embodiments the user may associate their social network credentials with their respective personalized virtual account. For example, as shown in FIG. 4, the user may select a social network, such as “F” or “T” in section 401. Upon selecting a social network the user may be requested to enter their social network login information and the virtual file system may generate a personalized virtual account associated with the user's social network.

The user may access their personalized virtual account by providing login credentials. The login credentials may be the user's password and username entered during registration or the user's biometric data. In some embodiments the virtual file system may provide each user a unique username and password which may be used as the login credentials. For example, the user may select the “Sign In” button 311 and provide their login credentials when prompted. In some embodiments the user may enter their login credentials into section 302 and select the “LETS GO!” button 411, as shown in FIG. 4. In the event the user has a personalized virtual account associated with a social network, the user may select the associated social network in section 401, and enter their social network login information to access their personalized virtual account.

The visual file system may store the user's login credentials, such as in storage device 150. Upon subsequent visits to the visual file system the user may automatically be logged into their personalized account using the stored user's login credentials. In some embodiments the user may remain logged into their personalized account for a predetermined period, such as an hour, a day, a week, a year, or more or less. Alternatively, the user may remain logged in for an indefinite period of time.

The visual file system may provide a selection interface to the computing device upon the user logging into their personalized account. The selection interface may include one or more visual environments in a graphical user interface that the user may access. Each visual environment may be a two-dimensional or three-dimensional virtual representation of a house, building, and/or location wherein a user may retrieve, view, or otherwise manipulate digital content. In this regard, the user may select his or her own personal environment and/or other users' environments to which they were provided permission to enter, such as by being invited to the other environments.

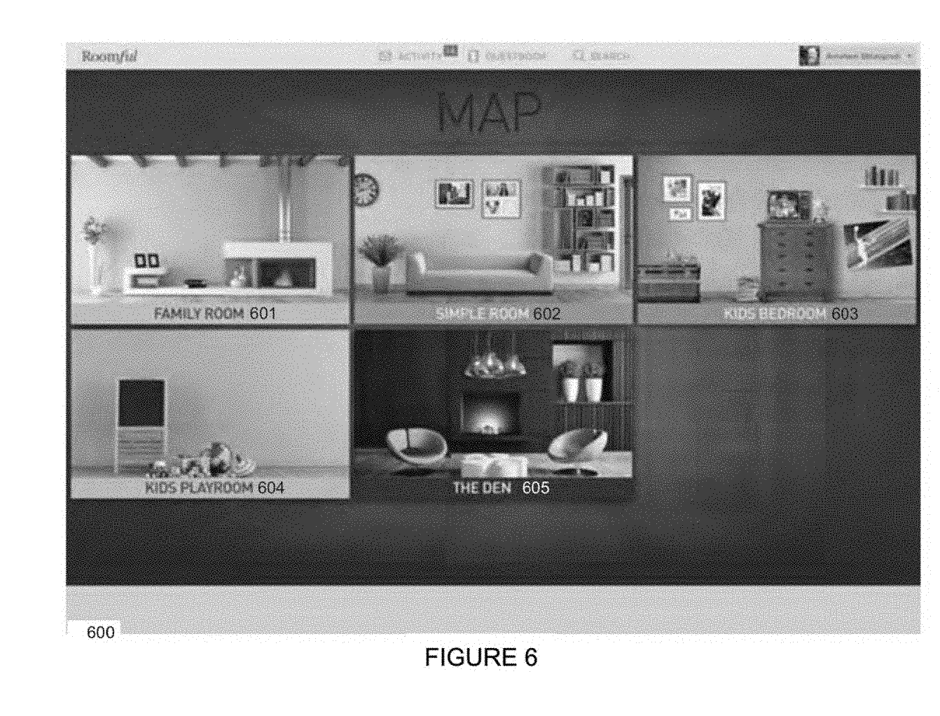

For example, as shown in FIG. 5, the user may be presented an environment selection interface 500. The environment selection interface 500 may include selectable icons “My Village” 501 and “My House” 503, which when selected, may provide the user with access to other users' virtual environments to which they were given access to enter or a personal environment, respectively. Although environment selection interface 500 shows only a single house and a single village, other villages each corresponding to groupings of other users' virtual environments, and other houses each corresponding to a different personal environment may also be shown. In some embodiments a different interface than the environment selection interface may be provided by the visual file system upon a user logging in.

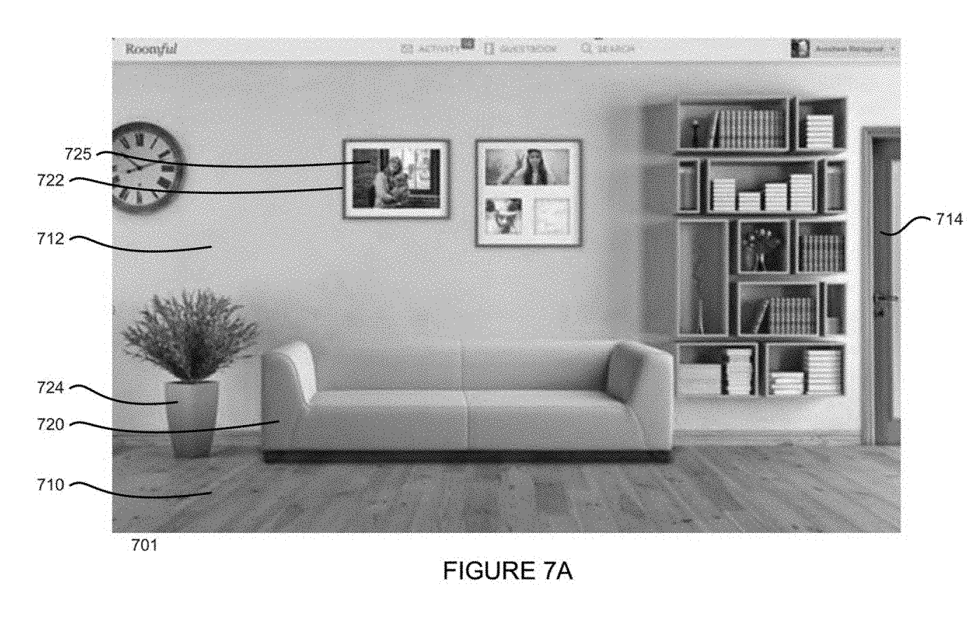

The visual file system desirably provides a room selection interface for display on the computing device upon the user selecting a given environment. The room selection interface may include an overview of the rooms contained within the selected virtual environment. For example, upon the user selecting the “My House” 503 icon from the selection interface 500, a room selection interface 600 may be displayed, as shown in FIG. 6. The room selection interface 600 may provide selectable room images corresponding to the rooms within the user's personal virtual environment. Such selectable room images include 601-605 which correspond to the rooms contained within the user's personal virtual environment (i.e., family room, simple room, kids' room, kids' playroom, and the den).

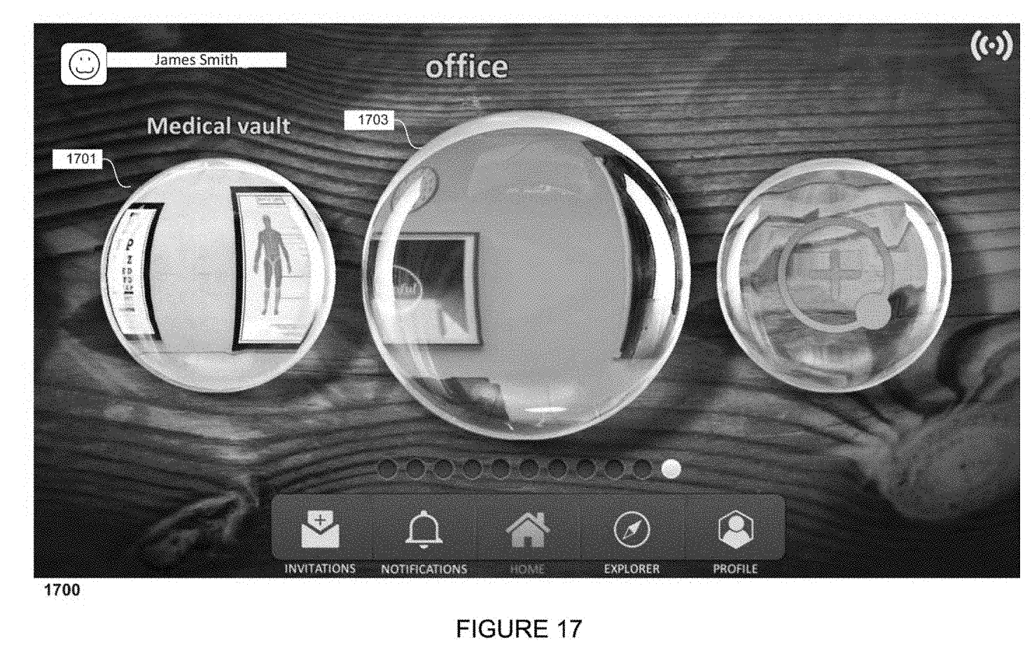

In another example, upon the user selecting the “My House” 503 icon from the selection interface 500, a room selection interface 1700 may be displayed, as shown in FIG. 17. The room selection interface 1700 may provide selectable room images corresponding to the rooms within the user's personal virtual environment. Such selectable room images include 1701-1703 which correspond to the rooms contained within the user's personal virtual environment (i.e., medical vault and office).

In some embodiments the room selection interface may present the selectable room images in a particular order and/or separate different rooms into floors. In this regard, the user may customize their personal virtual environment according their preferences. For example, the user may place all of the rooms corresponding to bedroom on a second floor and a living room and kitchen on a first floor.

In some embodiments the user may select virtual environments other than a house. These virtual environments may include any type of building or location such as a library, a town hall, a subway station, a park, a street, etc. In the event the selected virtual environment does not have rooms, a corresponding selection interface may be displayed, or no selection interface may be displayed at all. In this regard, the interface may display the corresponding selection interface which provides an overview the different locations within that virtual environment, or progress directly into the virtual environment. For example, if the virtual environment is a park, the different selection interface may display selectable images corresponding to the various locations within the park.

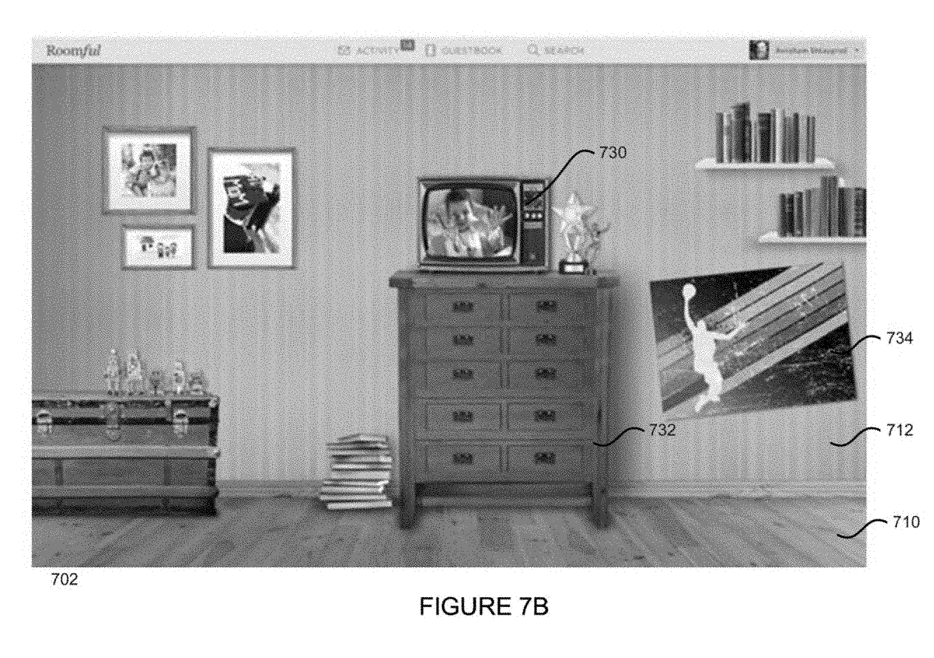

Upon a user selecting one of the selectable room images, the visual file system provides the room of the virtual environment corresponding to the selected room image to the computing device for display. For example, upon the user selecting room image 602, the visual file system may provide, to the computing device, living room 701, as shown in FIG. 7A. In another example, upon the user selecting room image 603, the interface may show a kids room 702, as shown in FIG. 7B.

Each room may be constructed of one or more structures and/or objects (“room components”). For example, the rooms may be constructed of structures which may include visual assets such as a floor 710, a wall 712, doors 714, ceilings (not shown), etc. The combination and arrangement of the structures may determine the size, shape, and layout of the room. Details such as room dimensions, colors, and structure placement (e.g., the positioning of the windows on a particular wall), may also be customized by the user or otherwise arranged according to a particular theme, as discussed further herein. In another example, a virtual park environment may include structures such as walking paths, streets, ponds, etc.

According to one aspect, objects are also placed within the rooms. Objects may include any non-structural article positioned within a room. For example, as further shown in FIG. 7A, objects within the living room 701 include a couch 720, picture frames 722, and a plant 724. In FIG. 7B, objects such as a television 730, dresser 732, and picture 734 are in the kid's room 702. The objects shown in FIGS. 7A and 7B are merely for example purposes and rooms may contain any number or type of objects. Further, objects may be added, deleted, and/or rearranged by the user. In some embodiments users may create objects or the objects may be provided by the virtual file system.

Each room may represent a container (or containers) for storage of different types of digital content. For instance, the living room 701 may represent a container for a family's digital content such as family albums, while the kid's room 702 may represent a container for the child's digital content such as favorite books or shows. In this regard, the combination of structures and objects within a room may be arranged such that a user can easily further identify the digital content contained within that room. For example, the picture frame 722 and couch 720 evoke a living room to a user, while the dresser 732, television 730, and sports picture 734 evoke a kid's room to a user.

The visual file system associates digital content with selected room components. In this regard, real world items are typically stored by placing them on the wall, on the floor, within furniture pieces, within or upon specially designed placement containers (e.g., bookshelves, desks, filing cabinets, etc.). Similarly, according to the visual file system, digital content may be stored in association with room components in a room. For example, the user may create an attic room in their personal virtual environment and place container objects in the attic room. The user may then associate digital content which is seldom accessed with the container objects in the attic room. Each virtual environment and/or object may be tagged with one or more words, such as “kid's room” or hashtags which describe the content associated with the room or objects.

In some embodiments, room components may act as props. In this regard, props may have no associated digital content, but rather serve the purpose of complimenting other room components within a room such that a user can easily further identify the digital content contained within that room. For example, the couch 720 may act as a prop and evoke a living room to a user. The user may then expect the digital content contained within the picture frame 722 to include images of a family.

The user may associate digital content with a room component by selecting the structure or object. For example, the user may select picture frame 722 in FIG. 7A via a cursor, mouse pointer, touchpad input, etc., and associate picture. Upon the user associating the picture 725 with the picture frame 722, the computing device may upload a copy of the digital content to the visual file system. The visual file system may store the digital content in storage, such as storage device 150 or a third party storage location (e.g., a cloud system).

A copy of the digital content may be stored in conjunction with data indicating the object(s) or structure(s) with which the digital content is associated. In this regard, digital content may be associated with more than one object and/or structure and the visual file system may store a single copy of the file. Alternatively, a copy of the digital content may be stored for each object or structure with which the digital content is associated.

Upon a user requesting the digital content associated with a room component, for instance by navigating to a particular room in the house and selecting an object in the room, the visual file system may determine if a local copy is available. In this regard, the visual file system may cause the computing device to determine whether a locally available version of the requested digital content is available. In the event a local version is available, the visual file system may cause the computing device to open the local version of the digital content. Otherwise, the visual file system may transmit a copy of the requested digital content to the computing device. In some embodiments the visual file system may transmit the copy of the requested digital content to the computing device without determining if a local version is available.

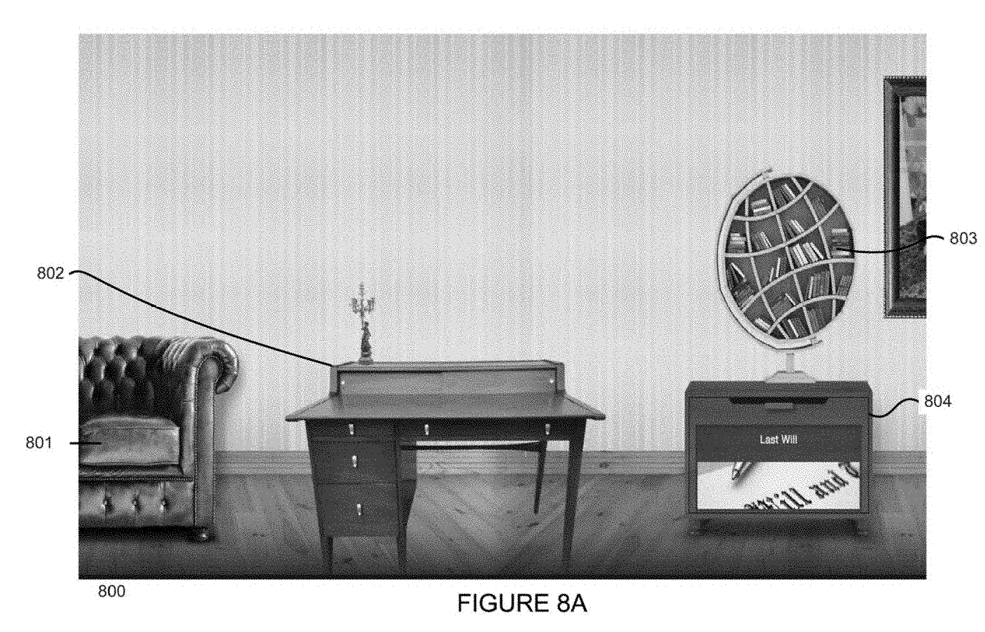

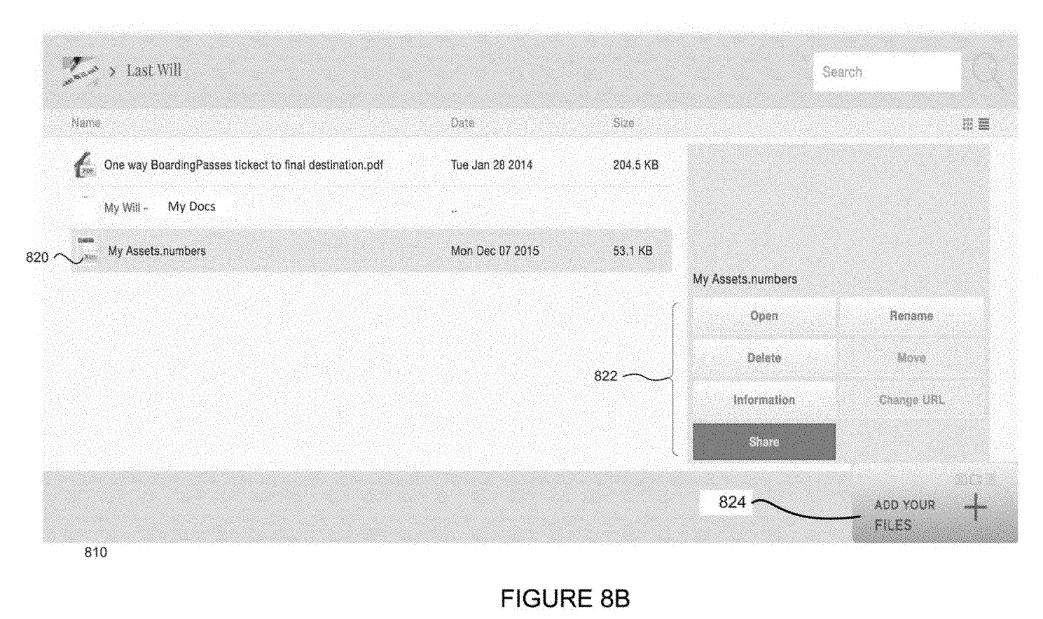

The user may associate, disassociate, and otherwise interact with the digital content associated with a structure or object by selecting the structure or object. For example, the user may navigate to the office room 800 of the personal virtual environment which includes object commonly found in an office including a couch 801, desk 802, globe 803, and filing cabinet 804. Upon selecting the filing cabinet 803, a file selection interface 810 may be displayed, as shown in FIG. 8B. From within the file selection interface the user may open, delete, rename, share, move, and otherwise interact with the digital content associated with the filing cabinet 803. The user may select one of the files, such as “My Assets.numbers” 820, and select an operation to perform with the file as provided in the control panel 822. The user may also add (i.e., associate) files to the filing cabinet 803 by selecting the “Add Your Files” icon 824.

Room components may be associated with third party digital content in the file selection interface. In this regard, a user may navigate from within the file selection interface to a third party location, such as a URL address or networked attached storage device, and select a file. The visual file system may store the location of the selected third part digital content in association with the selected objects and/or structures. In some embodiments the visual file system may make a copy of the third party digital content.

The digital content associated with the structures and objects may be static and/or dynamic. For example, as described above, a digital photograph may be associated with the picture frame 722 and may be statically displayed. However, the user may associate more than one digital photograph with the picture frame 722 and the picture frame may dynamically update the digital photograph which is shown in the picture frame 722. In some embodiments the user may be taken to a slide show which may include music and a presentation of the digital photographs when the user selects the picture frame 722. In another example, the user may associate videos or video channels with an object, such as the television 730 of FIG. 7B. The user may select and view the videos or video channels within the television 730 or television may automatically play the videos or video channels. The user may be provided an option to control whether digital content is displayed statically or dynamically.

Dynamic digital content may be associated with room components. For example, the user may associate an RSS feed or a social media feed with an object. The object may then display the latest updates to the RSS feed or social media feed automatically.

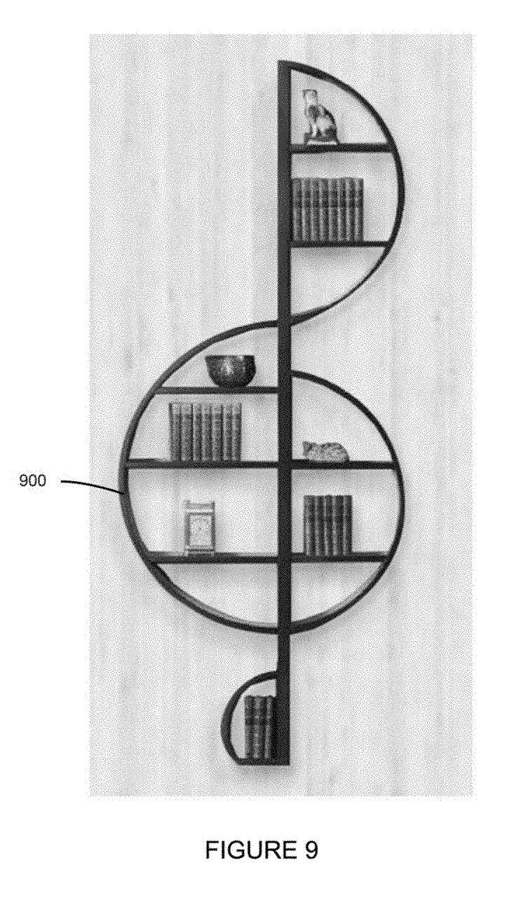

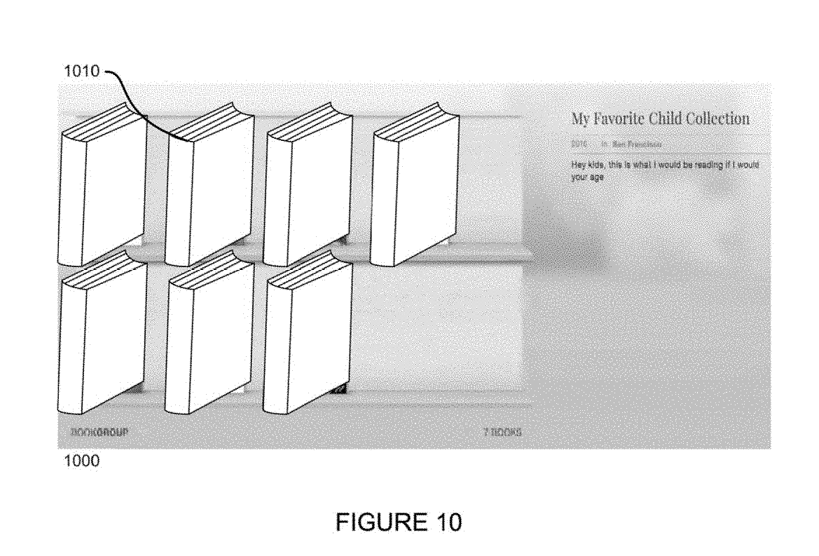

In some embodiments, room components (i.e., structures and objects,) may be configured to store associated digital content of a particular type. In this regard, structures and objects may be preprogrammed for association with particular digital content, preprogrammed for association with multiple types of digital content, and/or preprogrammed such that no association with any digital content may be made. As such, a user may easily determine the type of information associated with the object. For example, a room may include an object represented by a bookshelf 900, as shown in FIG. 9. The bookshelf may only be associated with digital content such as books, magazines, and newspapers. Upon a user selecting the bookshelf 900, a file selection interface 1000 including books 1010 associated with the bookshelf may be displayed on the computing device as shown in FIG. 10. In other examples, a CD-rack object may be associated with digital content including digital albums, podcasts, etc., and a television object may be associated with videos or video channels.

In some embodiments digital content representative of a collection may be associated with a room component. For example, digital content of the same kind (e.g., digital stamps, digital coins, etc.,) can be stored and presented on a table object. As such, a user will recognize the object contains a collection of similar objects.

The room components may visually update upon content being associated with the object. For example, referring back to FIG. 8A, the user may caption the filing cabinet “Last Will” to indicate the digital content associated with the filing cabinet is related to a will. In some embodiments, the room components may automatically update based upon the content associated with them. In this regard, the objects and structures may be preprogrammed to automatically update in appearance upon digital content being associated. For example, the user may select picture frame 722 in FIG. 7A, and associate picture 725. Picture frame 722 may automatically update to show picture 725 upon the picture being associated with the object.

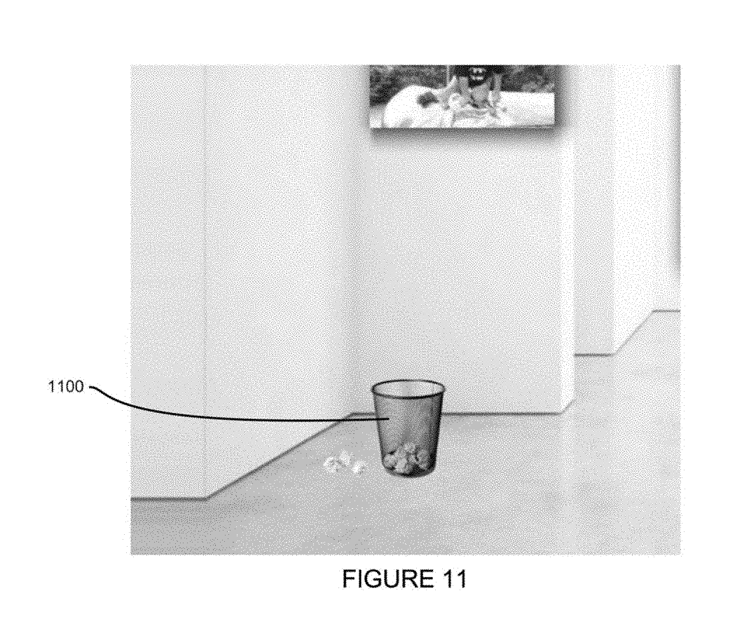

Objects and structures may be removed from a room, for instance by dropping them in a trashcan. For example, as shown in FIG. 11, objects and or structures may be dragged to trashcan 1100. Upon placing the object or structure in the trashcan the object or structure may be removed from the room. The digital content associated with the object or structure may also be removed from the visual file system at the same time or in the same way.

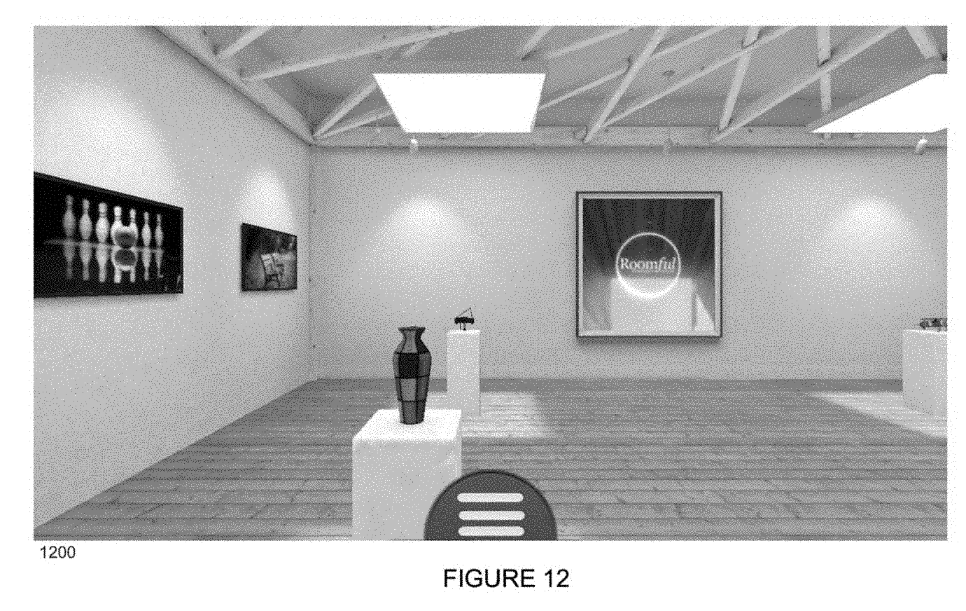

In some embodiments the rooms may be three-dimensional. For example, FIG. 12 shows a three-dimensional room in which a user may navigate via a graphical user interface. In this regard, the user may cause the display of the computing device virtually “move” through the room. In some embodiments the three-dimensional room may be projected to a user via a virtual reality headset, such as computing device 140. As such, the user may navigate virtually through the three-dimensional room.

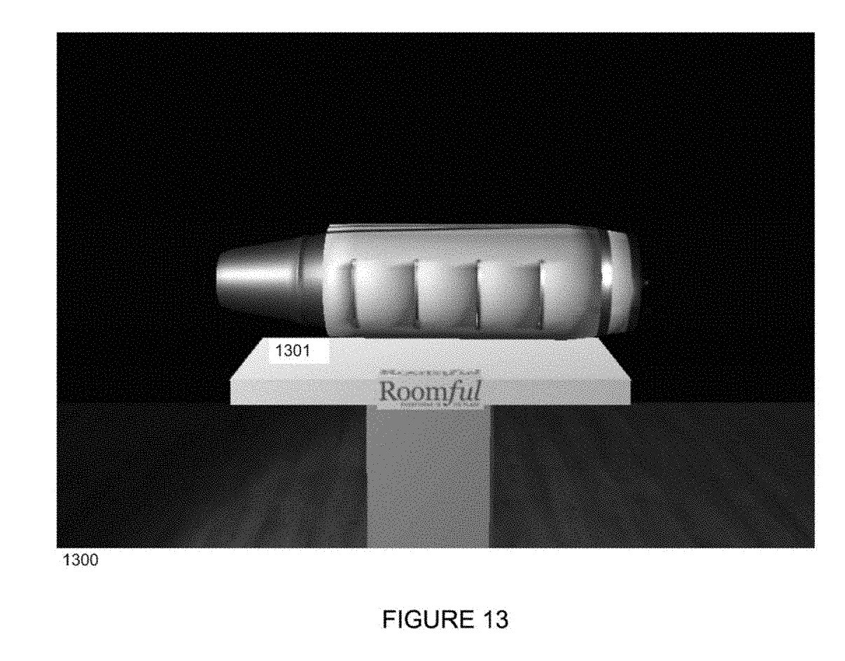

Objects within the room may also be three-dimensional. Digital content may be associated with the three-dimensional structures and objects. For example, three-dimensional room 1300 may include a three-dimensional engine object 1301, as shown in FIG. 13. The three-dimensional objects may be positioned on particular props, such as a table or stand or on any other such surface, such as a floor or wall. The user may associate digital content with the engine object 1301, such as a document outlining the technical specification of the engine, a two or three-dimensional model animation of the engine, a two or three-dimensional game associated with the engine. For example, the user may associate a technical specification document with the engine object 1301, and upon the user accessing the engine object 1301, the technical specification document may be presented to the user.

A user may navigate within the three-dimensional room 1300 and view all angles of the three-dimensional engine object 1301. Additionally, the user may navigate through the three-dimensional object. In this regard, as the user navigates through the three-dimensional object, the interior of the three-dimensional object may be displayed. For example, as the user navigates through the three-dimensional engine object 1300, the interior of the engine object may be displayed.

A user may join a virtual social network which includes other users of the virtual file system. A user may connect with other users on the virtual social network to develop a collection of followers. In this regard, the user may request other users to follow them and/or other users may request to follow the user. The user and other users may accept or decline such requests.

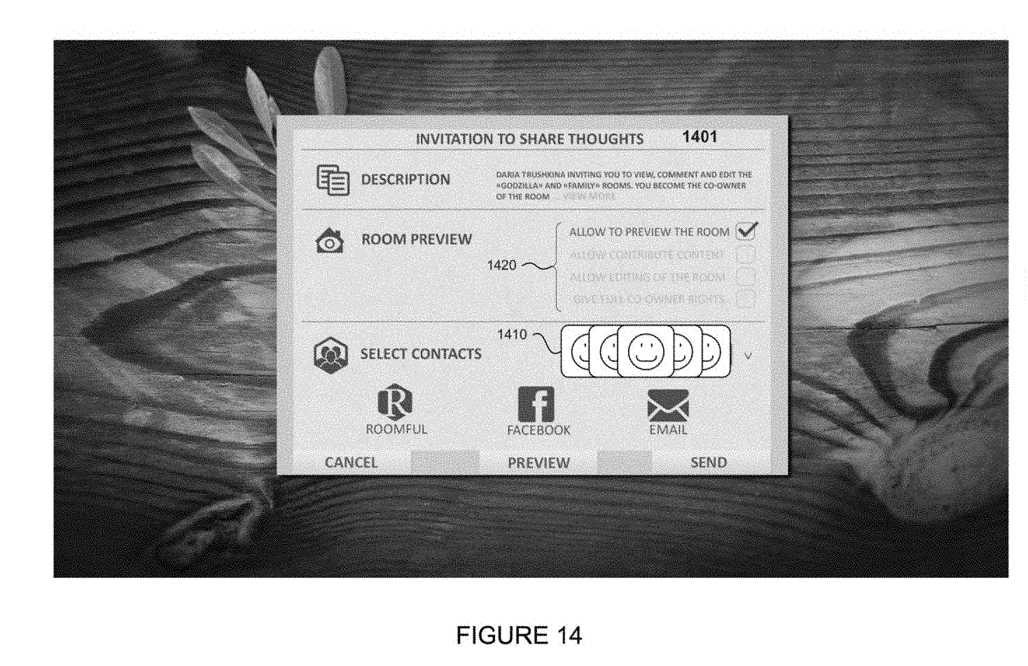

The user may create an invitation to one or more of their followers which grants access one or more virtual environments. For example, as shown in FIG. 14, a user may use an invitation generator 1401 to create and transmit an invitation to one or more of their contacts (i.e., followers). The invitation may grant selected followers access to one or more virtual environments of the user. The invitation may grant selected followers access to view only content associated with a virtual environment and/or object.

The invitation generator 1401 may include a virtual environment selection interface, not shown. From the virtual environment selection interface the user may select which of one or more virtual environments they wish to invite followers. The one or more virtual environments may include any virtual environment controlled by the user, such as a room, building, village, street, park etc. For example, the one or more virtual environments may include a family room, living room, library, kitchen, and/or bedroom of the user's virtual house.

Moreover, the one or more virtual environments may include social environments belonging to a collection of users, such as a village, or virtual environments within the village, such as a store, team room, community room, hall of fame, classmate's room, communal kitchen, show room, waiting room for a business, personal museums or memorials, collective museums or memorials, museum of history, museum of places and/or people, etc. Further yet, the one or more virtual environments may include event spaces which may represent a common space for users that participate in a certain event, club, or interest. For example, an event-space may include a virtual environment dedicated to family vacations or trips with friends, a virtual environment dedicated to the birth of a child, a virtual environment dedicated to a band, or any other event, club, and interest.

The invitation generator 1401 includes a follower selection interface 1410. The follower selection interface 1410 provides a listing of followers from which followers may share the one or more virtual environments. The follower selection interface 1410 may allow a user to select followers belonging to the virtual social network, as well as users who are not followers on the virtual social network, such as locally stored contacts, and/or followers of other social networks. The follower selection interface 1410 may recommend followers based on the one or more virtual environments being shared and the history/interests of the followers.

The invitation generator 1401 includes an interaction interface 1420. The interaction interface 1420 may allow the user to select levels of interactivity the selected followers may have with the selected one or more virtual environments, objects within the one or more virtual environments, and the contents associated with the one or more virtual environments and/or objects. Levels of interactivity may include ownership, contribution permission, editing/moderating permission, and commenting permission. Ownership permission may grant the selected followers co-ownership of the one or more virtual environments. As such, selected the followers may have unrestricted access to edit the one or more virtual environments including its objects and content, and further, the selected followers may edit other followers access rights to the one or more virtual environments. Contribution permission may grant selected followers the ability to add and/or associate content to the one or more virtual environment and objects within the environments. Editing/moderation permission may grant the selected followers the ability edit the arrangement of the one or more virtual environments and objects therein and moderate the content associated with the one or more virtual environments and objects therein. Commenting permission may grant the selected followers the ability to comment on the one or more virtual environments and the content therein.

The generated invitation may have an expiration period. In this regard, the user may define a time-restriction on the selected followers' access to the one or more virtual environments. Such time-restricted access may be of any length of time, such as seconds, minutes, hours, days, weeks, months, years, etc. Similarly, the time-restricted access may be defined as a number of visits by the follower to the virtual environment, such as one visit, two visits, etc.

The user may schedule the time-restriction to start at the time the invitation is sent and/or when the respective selected follower accesses the one or more virtual environments. For instance, the user may provide a follower access to a virtual environment for one hour calculated from the time the follower spends in the virtual environment. As such, the follower can access the virtual environment for up to one hour in total. Upon expiration of the hour, the follower may be removed from the virtual environment.

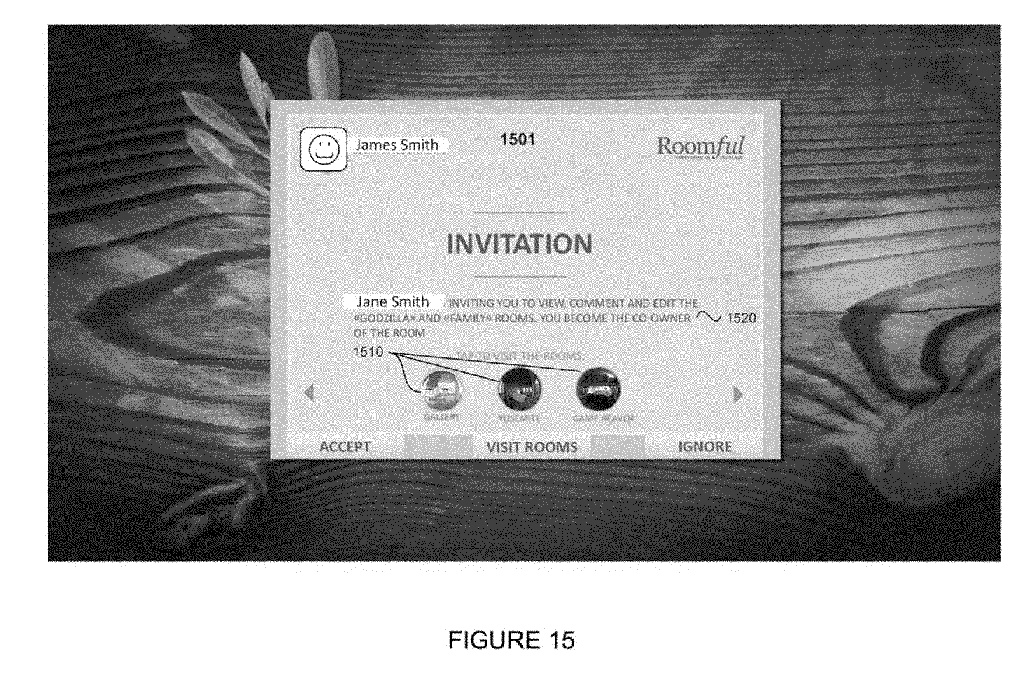

The selected followers may receive an invitation from the user indicating the locations to which they are being offered access. For example, as shown in FIG. 15, a follower, James Smith, may receive an invitation 1501 from Jane Smith. The invitation 1501 may include a listing of the virtual environments 1510 to which the follower is being invited and a listing of the levels of activity 1520 granted for each virtual environment. The follower may accept or ignore the invitation 1501. The follower may select one of the virtual environments from the listing of virtual environments and be taken to the selected virtual environment.

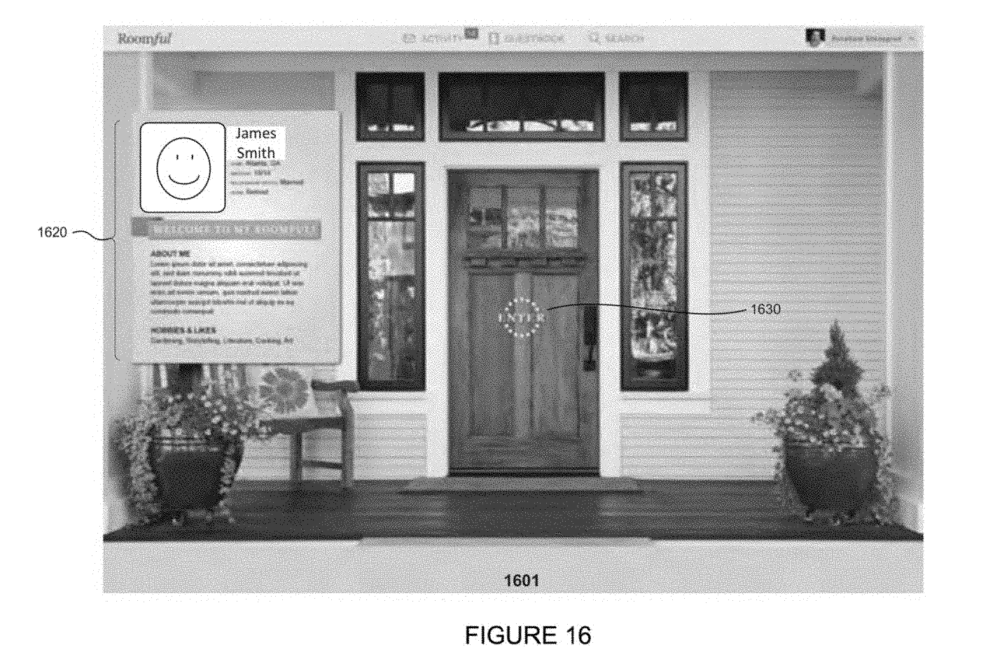

A user may request access to another user's virtual environment. In this regard, the user may select the other user's virtual environment for which they would like to view, and request access. For example, as shown in FIG. 16, upon selecting a virtual environment representing James Smith's house, the user may be presented a welcome screen 1601. The welcome screen 1601 may include a description of the virtual environment and the user who own the virtual environment 1630. Further, the welcome screen may allow a user to virtual front door 1630, which the user may select to request access to the virtual environment. Upon requesting access the owner of the virtual environment may be provided with a notification that a user has requested access. The owner may then grant or deny the user access to the virtual environment. The owner may provide a level of interactivity and time-restriction on the user. Owners of virtual environments may make their virtual environments private. Private virtual environments may not be visible to other users on the virtual social network.

A user may pre-emptively provide access, level of interactivity, and time-restrictions to one or more virtual environments. In this regard, a user may assign access permissions based on the other user's profile, history, and/or interests. For example, a user may pre-emptively grant access to a club house for baseball players to all users of the social network with a profile indicating they played professional baseball. In another example, a user may pre-emptively grant access to a club house to users who were born in Russia and currently live in the United States.

Each virtual environment, including the contents and objects contained therein, may be associated with commentary and feeback. In this regard, users with access to a virtual environment may leave comment and feedback for the owner of the virtual environment and/or other users who visit the virtual environmnent. The owner of the virtual environment may enable or disable the ability for users to leave feedback and commentary. The owner of the virtual environment may also moderate the feedback and commentary, or enable another user to moderate the feedback and commentary. The virtual environments may also include a locations where users can communicate, such as through a dialog box or via audio.

Users of the social network may pin their favorite virtual environments to their environment selection interface 500. The environment selection interface 500 may also provide recommended virtual environments based on the user's interests, the user's history of places previously visited, and virtual environments provided by their followers. The environment selection interface 500 may also provide users with access to publicly accessible virtual environments. In this regard, the user may search for public virtual environments and/or be presented with an organized listing of the public virtual environments.

The virtual social network may aggregate content from other social network(s). In this regard, the virtual social network may monitor user's other social network(s) and present the content posted to and from the other social network(s) in a virtual environment belonging to the user. For example, the virtual social network may automatically create a room in a user's virtual environment based on the detected activity and/or content posted to the other social network(s). In one example the virtual social network may detect a group of photos captured during a ski trip were posted in social network “F”. The virtual social network may generate a room dedicated to the ski trip in the user's virtual environment and automatically place the photos in picture frames in the room. In the event a user comments on the content aggregated from another social network (e.g., the photos), the virtual social network may automatically post the comments may be the social network from which the content was acquired.

In some embodiments the user may create virtual environments or customize existing personal virtual environments by accessing a creation or editing interface (e.g., a room constructor utility) from the selection interface. For example, referring back to FIG. 5, the selection interface 500 may also include selectable a “Create” icon 507 and a “Customize” icon 505. Upon selecting the “Create” icon 507 the user may be provided with a virtual environment creation interface wherein the user may create a personal virtual environment. Upon selecting the “Customize” icon 505, the user may be provided with a virtual environment editing interface, wherein the user may edit a personal virtual environment. Both the creation interface and editing interface may allow a user to create or delete virtual environments, create and remove rooms, add and remove structures, and/or add and remove objects. Additionally, a user may associate or disassociate digital content with the structures and objects within the virtual environments.

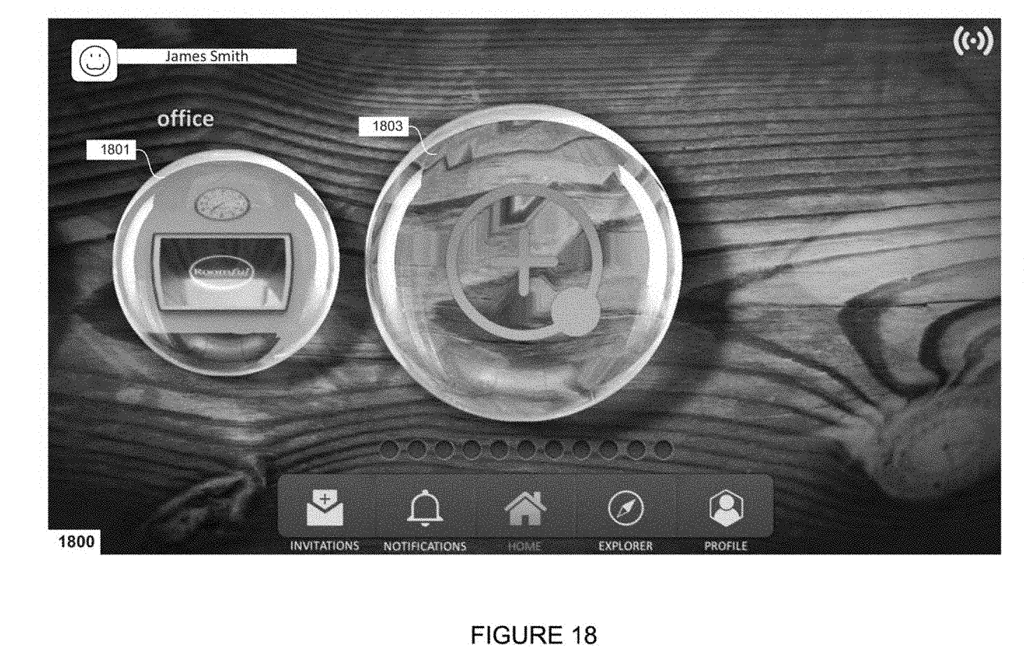

For instance, upon selecting the a “Customize” icon 505, the user may be presented with a room construction selection interface 1800, wherein a user may edit two-dimensional or three-dimensional rooms or other such locations within their virtual environments and/or add additional rooms and/or locations to their virtual environments, as shown in FIG. 18. In this regard, the user may select a previously created location, such as office 1801 where they may be taken to an editing screen to modify the selected room. The user may select an add button 1803 to generate a new location within the virtual environment.

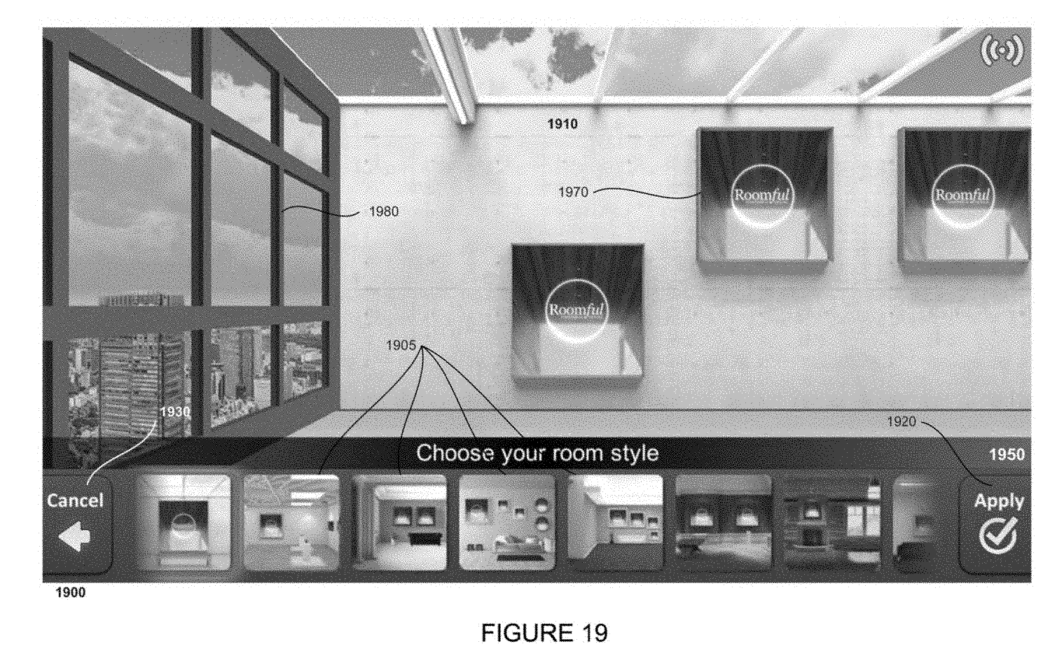

Upon adding a new location or selecting a location to edit, a room style interface 1900 may be displayed, as shown in FIG. 19. In this regard, a user may be presented with a two-dimensional default room 1910 and a room design ribbon 1950. The default room 1910 may include default objects, such as default object 1970 and/or default structures, such as default structure 1980. Alternatively, the room style interface 1900 may include the room design ribbon 1950 without a default room 1910.

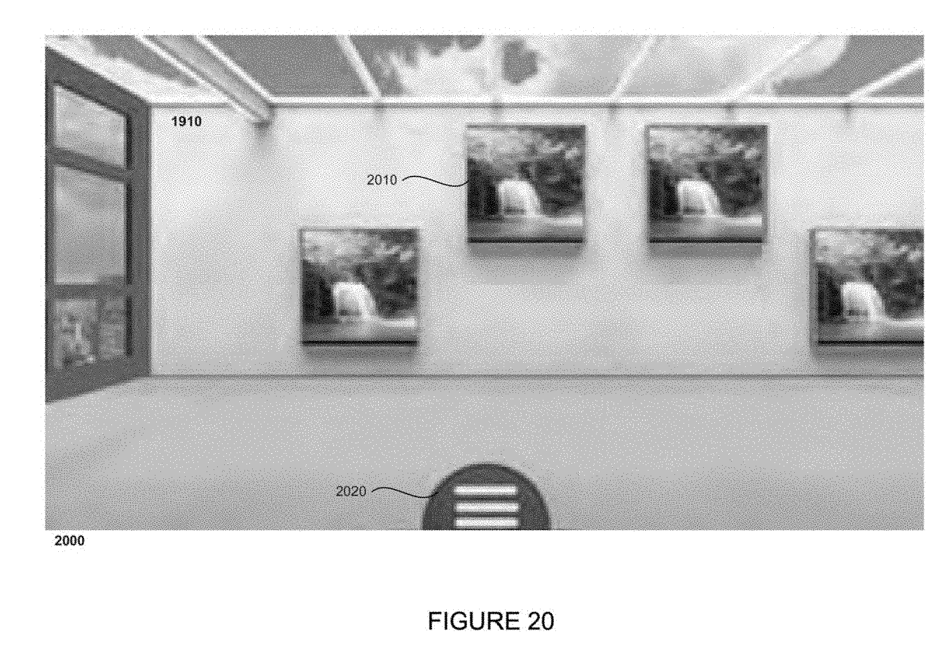

The room design ribbon 1950 may include one or more preconfigured room designs, such as one of the designs 1905, from which the user may select a design. Room designs may include the looks and feel of objects and structures which make up the aesthetic of the room. Upon the user selecting one of the designs the image of the room 1910 may switch to the selected room design. The image of the room 1910 may not switch until the user activates the apply button 1920, after selecting a room style. In the event the user wishes to exit the room style interface, the user may select the cancel button 1930 which may cause the display to switch to another interface, such as the room constructor selection interface 1800, the selection interface, or cause the display to show the virtual environment, such as default room 1910, in full screen, as shown in FIG. 20.

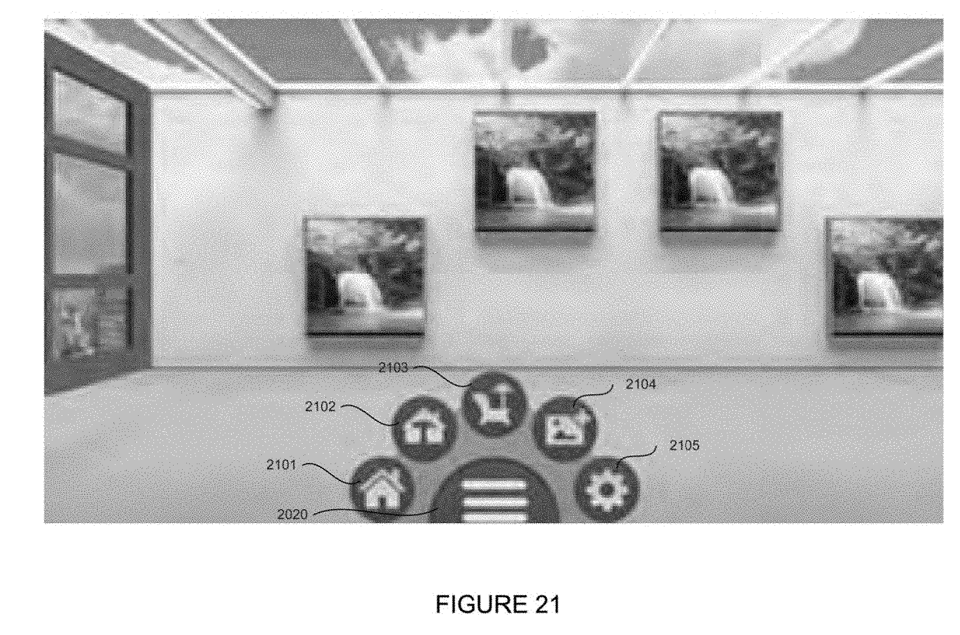

In the full screen interface 2000 the user may view the virtual environment they are in, such as default room 1910. A user may navigate within the displayed virtual environment and view all angles of the three-dimensional virtual environment. Additionally, the user may interact with room components within the virtual environment, such as object 2010. The full screen interface 2000 may also include a selectable menu 2020, which, upon being selected may cause contextual menus to be displayed, such as shown in FIG. 21.

The contextual menus may include a home menu 2101, a room constructor menu 2102, a room designer menu 2103, a content addition menu 2104, a settings menu 2105, etc. Upon selecting the home menu 2101 the display may switch to another interface, such as the room constructor selection interface 1800, the selection interface 1900, registration page 300, as shown in FIG. 3, a mobile registration page 400 as shown in FIG. 4, or some other interface or page. In the event the user selects the room designer menu 2103, the room style interface 1900 may be displayed, as shown in FIG. 19. A selection of the settings menu 2105 may cause the display to show a number of customizable settings for the visual file system such as default styles, font preferences, font sizes, and other such settings. Upon the selectable menu 2020 being selected while the contextual menus are displayed, the contextual menus may be removed from the display.

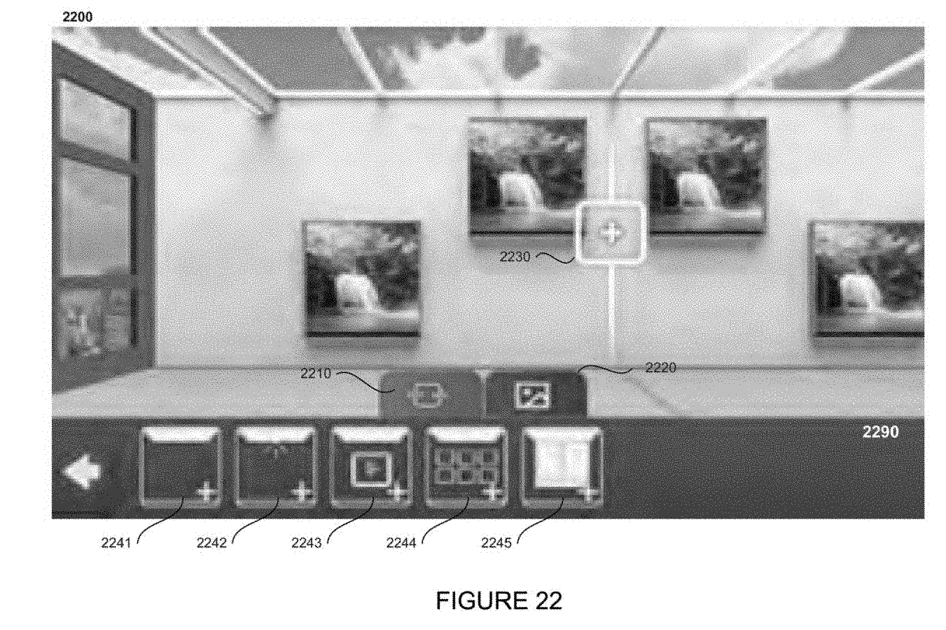

In the event the room constructor menu 2102 is selected, a room constructor interface 2200 may be displayed, as shown in FIG. 22. The room constructor interface 2200 may include two types of room constructor modes including a room modification mode and a room addition mode. The current room constructor mode may be indicated by highlighting a panel icon 2210 or a room icon 2220, which correspond to the room modification mode and room addition mode, respectively.

The room constructor interface 2200, as shown in FIG. 22, is in room modification mode, as indicated by panel icon 2210 being highlighted. Upon entering room modification mode, the room constructor interface 2200 may provide modifiable locations, such as modifiable location 2230, where structures, such as a floor, a wall panel, door, ceilings, etc., may be added. Modifiable locations, such as modifiable location 2230, may include a plus arrow to show a structure may be added to that location.

The structures which may be added to the modifiable locations may be presented in structure ribbon 2290, where each structure may be represented by a selectable structure icon, such as structure icons 2241-2245. Structure icons 2241-2245 may represent structures such as a blank wall panel, a panel with a light, a panel with an image object, a panel with multiple windows, a panel with a large window, respectively, although other structures may be selectable. The structure icons may be updated in real-time based upon the types of structures which may be added to the modifiable locations within the virtual environment or the structure icons may remain static. In some instances, the structure icons displayed may be blocked (e.g., grayed out or otherwise inaccessible,) when the structure associated with the structure icon is not compatible with the current portion of the environment being displayed in the room constructor interface 2200. Compatibility may be based on lighting or shadow differences, style differences, or other such differences between respective structures associated with structure icons and the environment being displayed. For example, the system may determine whether a structure icon which represents a panel in a different style than the environment being displayed is compatible or incompatible with the environment (if the panel may be placed somewhere within the displayed environment.) Based on the compatibility determination, the system may make the structure icon available for selection or gray out the structure icon.

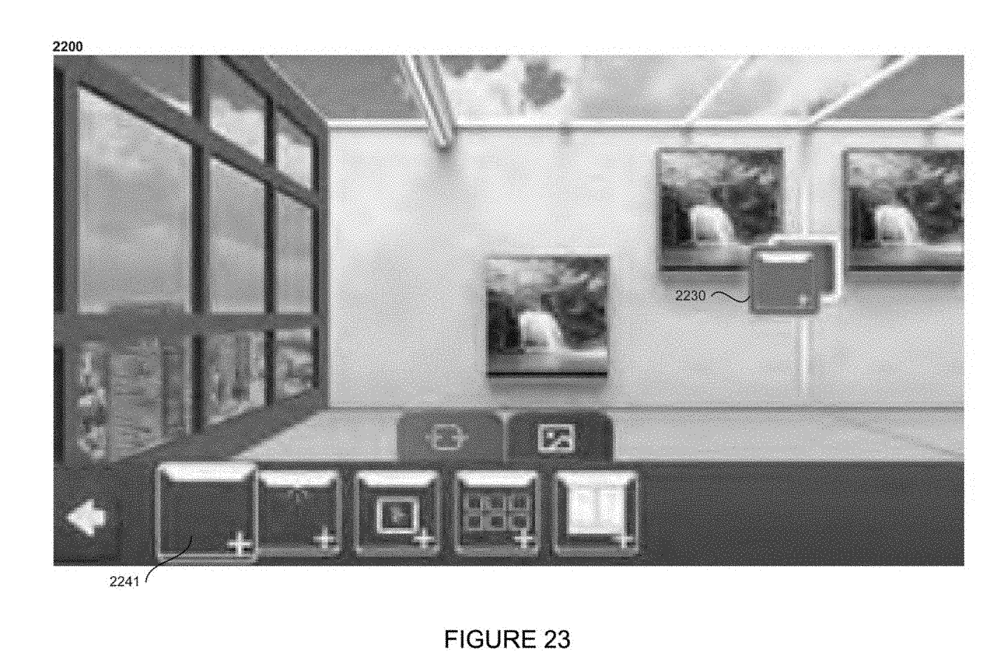

To add a structure to the modifiable location, a user may select one of the structure icons corresponding to the structure to be added from the structure ribbon 2290 and drop the structure upon the modifiable location where the structure is to be added. For instance, as shown in FIG. 23, structure icon 2241 may be selected and dragged and dropped upon the modifiable location 2230. In some embodiments the user may simply select the structure icon and then the modifiable location where the structure is to be added.

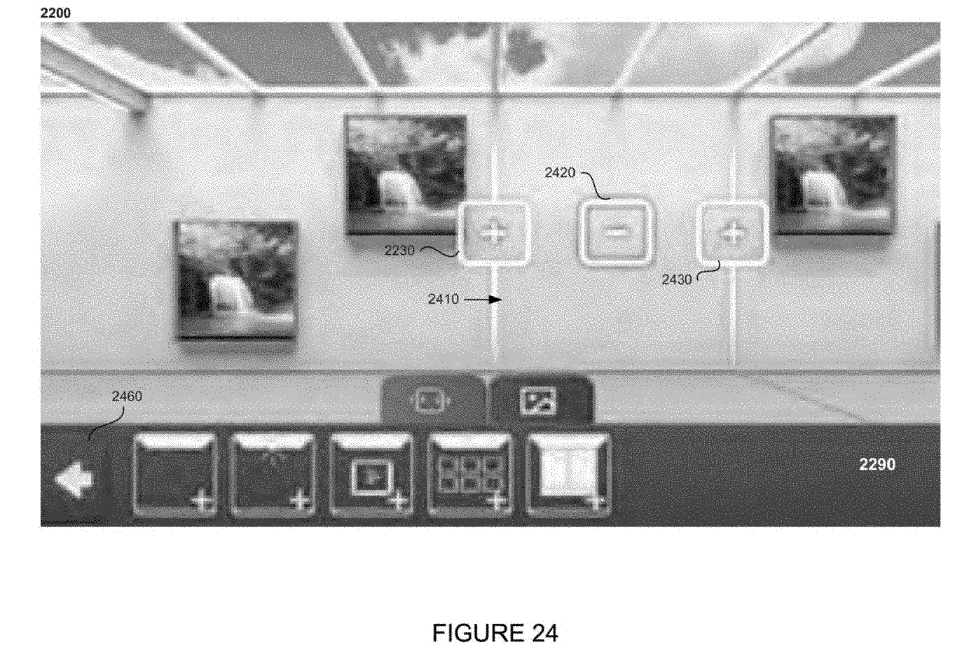

Upon dropping the structure icon 2241, the room constructor interface 2200 is updated to include the wall panel 2410 corresponding to the structure icon 2241, as shown in FIG. 24. Additionally, the room constructor interface 2200 is updated to show additional modifiable locations where structures may be added in view of the placement of the new structure (i.e., the wall panel 2410.) In this regard, modifiable location 2430 may be added to the room constructor interface and modifiable location 2230 may remain in the same location where it was located prior to the new structure being added.

Structures which may be removed from a room are associated with modifiable locations which include a subtraction symbol, such as modifiable location 2420 which is associated with wall panel 2410. For example, upon modifiable location 2420 being selected, the wall panel 2410 may be removed from the virtual environment.

The structure ribbon 2290 includes a back button 2460. Upon selecting the back button 2460, the room constructor interface 2200 may be exited and a different interface, such as full screen interface 2000, including the added wall panel 2410 may be presented. Alternatively, a different interface may be presented upon the back button being selected.

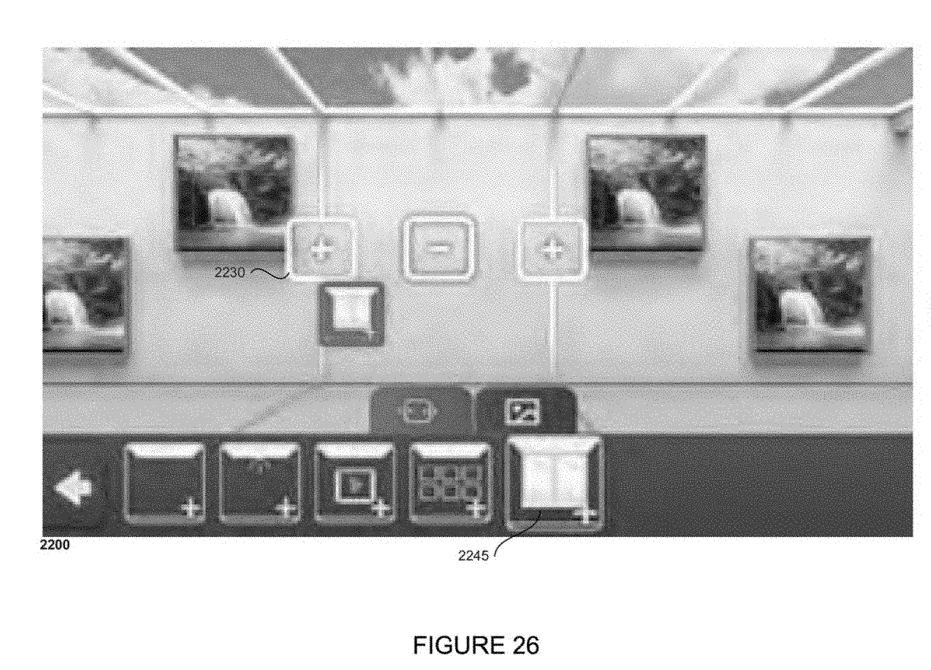

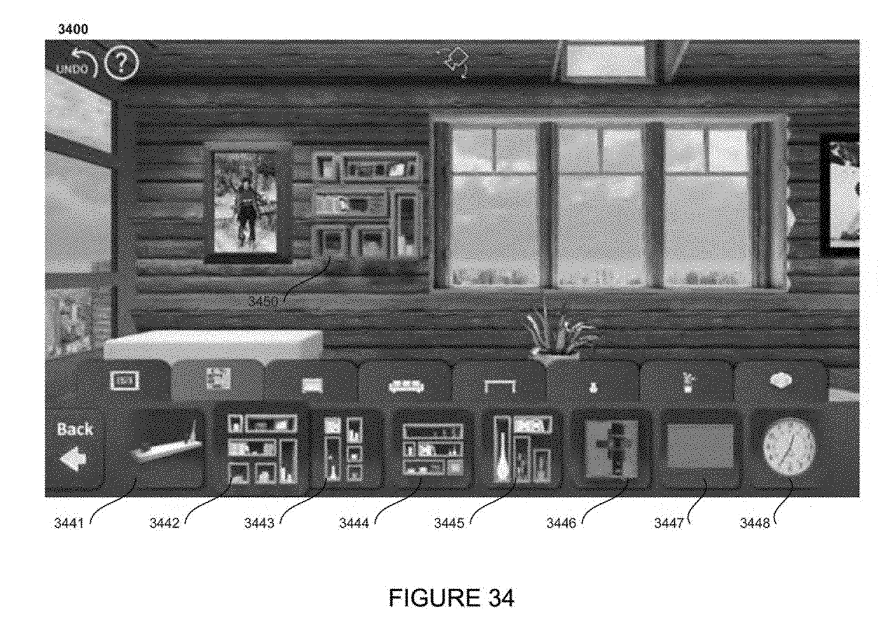

Structures which are added to a virtual environment may include objects. For instance, a panel with a large window, corresponding to structure icon 2241, may be added to modifiable location 2230, as shown in the room constructor interface 2200 of FIG. 26. Upon adding the panel with a large window 2750, additional objects, such as a tree 2710, a chair 2720, and a table 2730 may be added to the virtual environment. For instance, the content addition menu 2104, as shown in FIG. 21, may be selected causing the interface to display an object addition interface 3400, as shown in FIG. 34. The object interface may include a plurality of selectable object icons which represent objects which may be added to the virtual environment, such as selectable object icons 3441-3448. Selectable object icons 3441-3448 may represent objects such as bookcases and clocks and other such objects described herein. The object icons may be updated in real-time based upon the types of objects which may be added to the virtual environment, or the object icons may remain static. The object associated with a given selectable object icon may be dragged and dropped within the virtual environment by selecting an icon, such as icon 3442 associated with a bookshelf 3450. Upon dragging the object to an acceptable location the object may be outlined or highlighted as further shown in FIG. 34.

Each structure may be programmed to have no preprogrammed objects or one or more. Each object may be removable from the virtual environment.

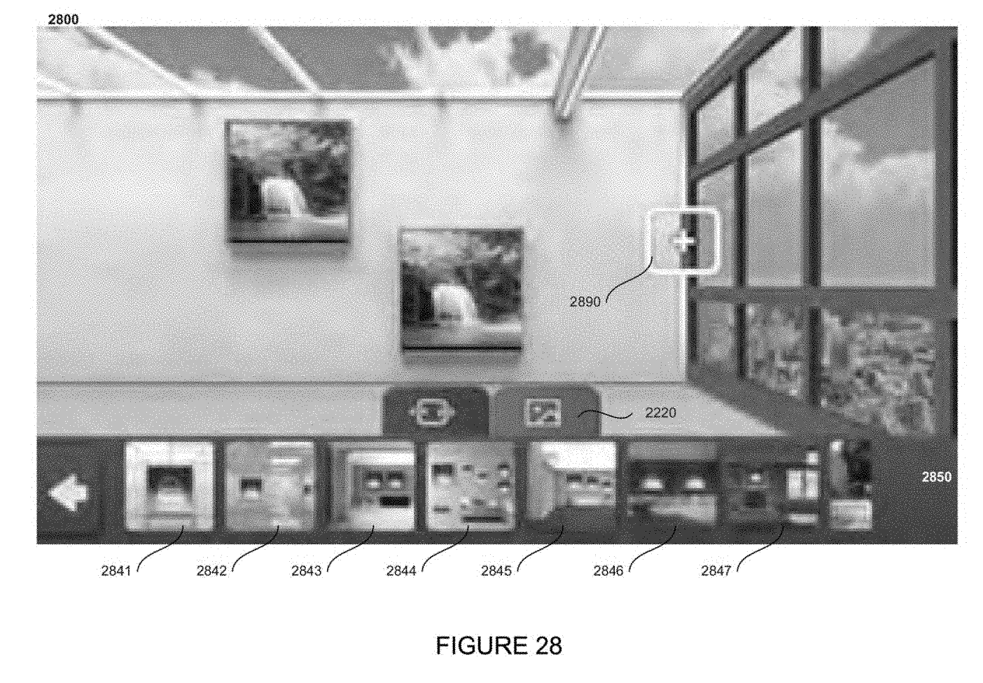

A user may enter the room addition mode by selecting room icon 2220, as shown in FIG. 28. Upon selecting the room icon 2220 a room addition interface 2800 may be presented. The room addition interface 2800 may provide modifiable locations, such as modifiable location 2890, where additional rooms may be constructed. In some embodiments rooms may be added only to the beginning or end of an existing room.

The rooms which may be added to the modifiable locations may be presented in room ribbon 2850, where each room may be represented by a selectable room icon, such as room icons 2841-2847. Room icons 2841-2847 may represent predefined room styles and configurations. The room icons 2841-2847 may be updated in real-time based upon the types of rooms which may be added to the modifiable locations within the virtual environment or the room icons may remain static. In some instances, the room icons displayed may be blocked (e.g., grayed out or otherwise inaccessible,) out when the room associated with a room icon is not compatible with the current portion of the environment being displayed in the room addition interface 2800. Compatibility may be based on lighting or shadow differences, style differences, or other such differences between respective rooms associated with the room icons and the environment being displayed. For example, the system may determine whether a room icon which represents a room in a different style than the environment being displayed is compatible or incompatible with the environment (i.e., if the room may be placed somewhere within the displayed environment.) Based on the determination, the system may make the room icon available for selection or gray out the room icon.

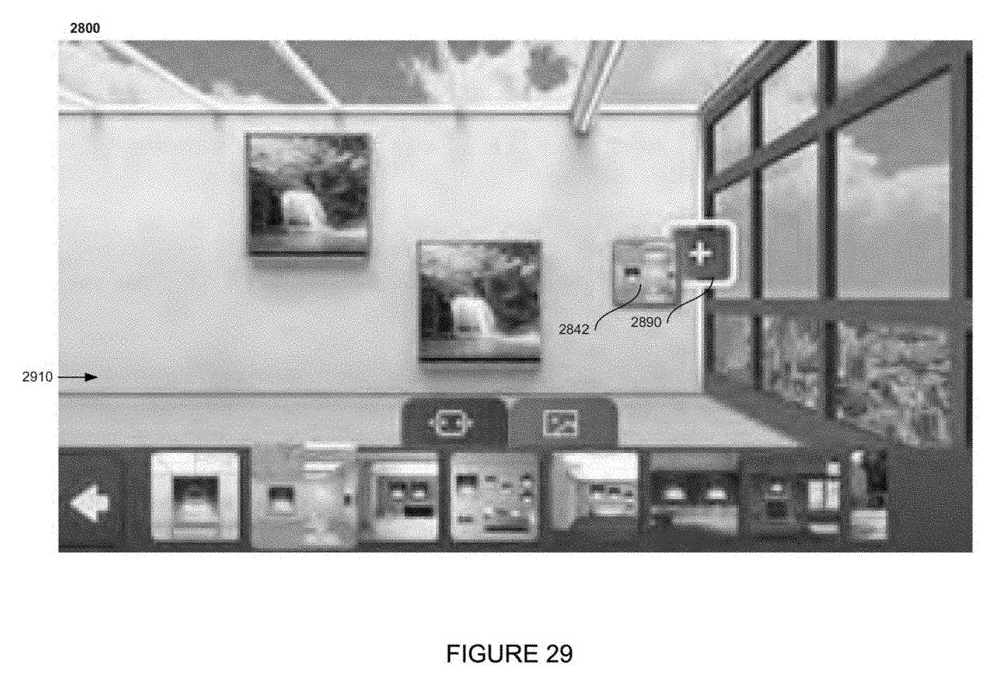

To add a room to an existing virtual environment, including room 2910, a user may select one of the room icons corresponding to the room style to be added from the room ribbon 2850 and drop the room icon upon the modifiable location where the room is to be added. For instance, as shown in FIG. 29, room icon 2842 may be selected and dragged and dropped upon the modifiable location 2890. In some embodiments the user may simply select the room icon and then the modifiable location where the room is to be added. In some embodiments no modifiable locations may be displayed; rather, the user may simply drag and drop a room icon onto the interface.

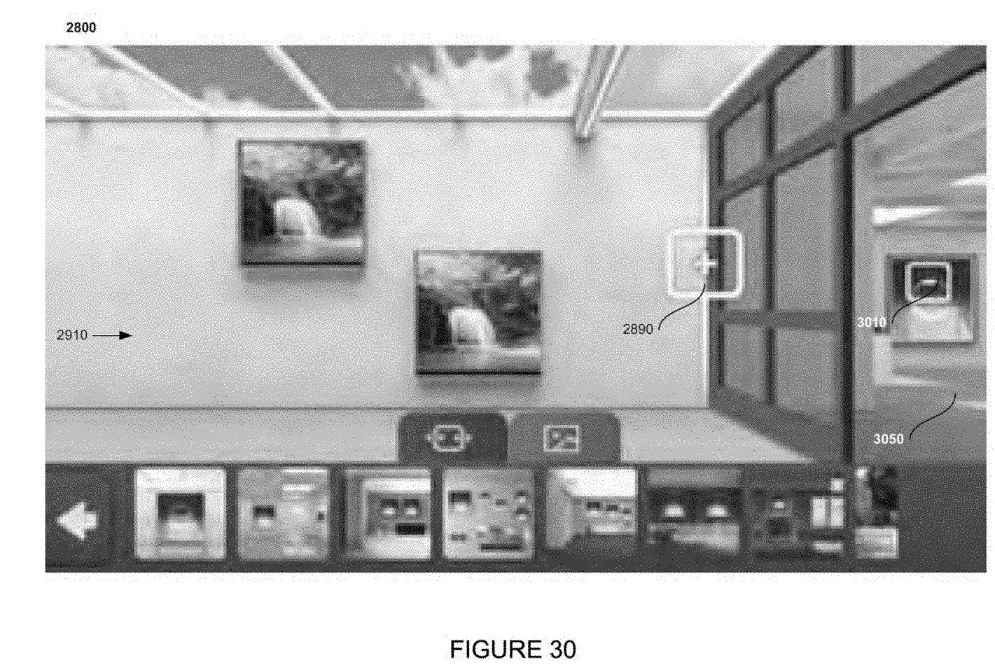

Upon dropping the room icon, the room addition interface 2800 is updated to include a new room 3050 in the style corresponding to the selected room icon, as shown in FIG. 30. Additionally, the room addition interface 2800 is updated to show additional modifiable locations where structures may be added or removed in view of the placement of the new room, such as modifiable location 3010. In this regard, modifiable location 3010 may be added to the room addition interface and modifiable location 2890 may remain in the same location where it was located prior to the new room 3050 being added.

Upon returning to the full screen interface 2000 the user may navigate between the new room 3050 and other connected rooms, such as room 2910. In this regard, a user may navigate within the displayed virtual environment and view all angles of the three-dimensional virtual environment. Additionally, the user may interact with room components within the virtual environment. As previously discussed the full screen interface 2000 may also include a selectable menu 2020, which, upon being selected may cause contextual menus to be displayed, such as shown in FIG. 21. A user may navigate between rooms in the room addition interface and/or the room constructor interface 2200.

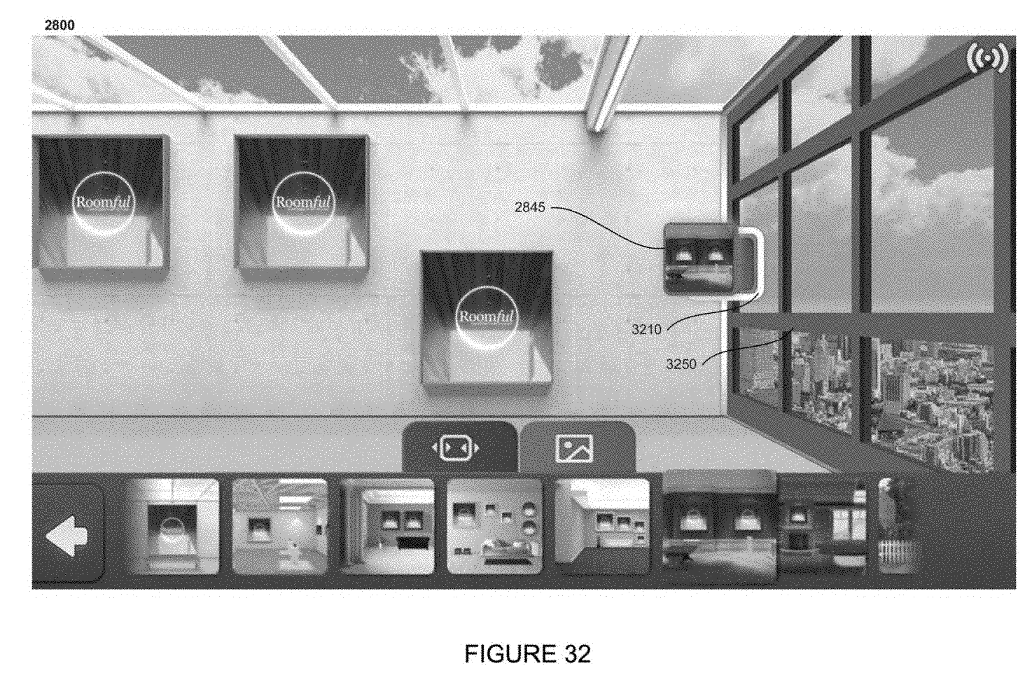

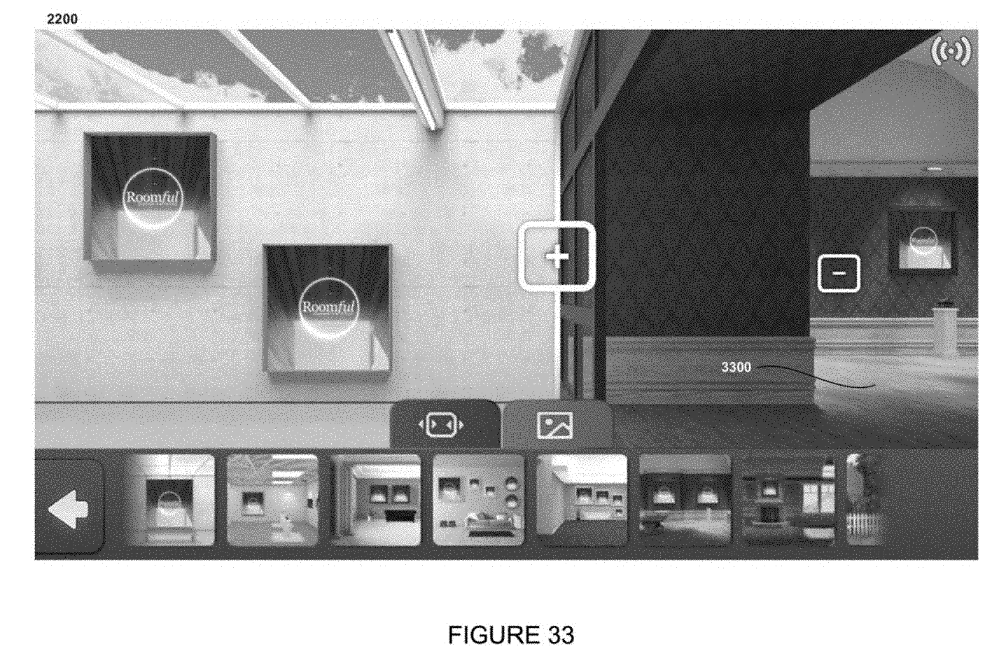

In another example of the room addition interface 2800, a user may select one of the room icons 2845 corresponding to the room style to be added from the room ribbon and drop the room icon 2845 upon the modifiable location where the room is to be added 3210, as shown in FIG. 32. As further shown in FIG. 32, the modifiable location 3210 may be next to a window wall 3250. Upon adding the new room 3300 the window wall 3250 may be removed to allow navigation between the new and old room, as shown in FIG. 33.

Users may control the aforementioned virtual file system and interfaces through user inputs. The user inputs may include inputs entered through a mouse, touchscreen, keyboard, virtual reality input controller, camera, or microphone. For instance a user may provide verbal inputs to control all aspects of the file system and virtual environment creation and modification. For instance, the verbal inputs may include commands such as:

“Create a Room according to the Room Template ‘X’ (or Room Style ‘Y’)”;

“Extend the room by adding a panel of the type ‘Y’ at the location ‘Z’ panel”;

“Extend the room by adding a new style Segment at the beginning/middle/end of the Segment X”; and

“Hey Roomful, extend room ‘Z’ by adding panel ‘X’ to the location ‘Y’.”

Upon completing or customizing a two-dimensional virtual environment with a computing device, such as computing device 120 with a two-dimensional flat or curved screen, the program may generate a three-dimensional virtual environment. Users may then navigate in the user-created three-dimensional virtual environments with a computing device, such as a virtual reality headset or augmented reality glasses. For instance, a user may navigate the three-dimensional virtual environment using computing device 140.

Unless expressly stated otherwise, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. As an example, the preceding operations do not have to be performed in the precise order described above. Rather, various steps can be handled in a different order, such as reversed, or simultaneously. Steps can also be omitted unless otherwise stated. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method for managing digital content with a visual file interface, the method comprising:
generating, with one or more processing devices, a virtual environment in a graphical user interface that comprises one or more rooms, each room including one or more room components therein;
receiving from a user device, by the one or more processing devices, a request to associate a digital file with a selected one of the one or more room components;
creating, by the one or more processing devices, the association between the digital file and the selected room component;
retrieving, by the one or more processing devices, the digital file; and
storing, by the one or more processing devices, the digital file in association with the one or more room components.

2. The method of claim 1 further comprising:
receiving, from the user device, a request to view the digital file; and
in response to the request to view the digital file, transmitting the digital file to the user device.

3. The method of claim 1 wherein the one of the one or more room components include one or more structures and/or one or more objects.

4. The method of claim 1 wherein the digital file is retrieved from a website or from the user device.

5. The method of claim 1 wherein the one or more room components are each selected from the group consisting of a piece of furniture, a bookcase, a file cabinet, a picture frame, entertainment element, and a piece of artwork.

6. The method of claim 1 wherein the virtual environment represents a house and the one or more rooms are located on floors within the house.

7. The method of claim 1 wherein the digital file is stored in a storage device remotely located from the user device.

8. The method of claim 7 further comprising:
receiving, from the user device, a request to delete the association of the digital file; and
in response to the request to delete the digital file, deleting the digital file from the storage device.

9. The method of claim 1, wherein when the digital file is stored in association with the one or more room components, an indicator is provided which shows the one or more room components contain the digital file

10. The method of claim 1, wherein when the digital file is a three-dimensional model, a three-dimensional animation, or a three-dimensional game.

11. A system for managing digital content with a visual file interface, the system comprising:
one or more computing devices; and
memory storing instructions, the instructions executable by the one or more computing devices;
wherein the instructions comprise:
generating a virtual environment in a graphical user interface that comprises one or more rooms, each room including one or more room components therein;
receiving from a user device, a request to associate a digital file with a selected one of the one or more room components;
creating the association between the digital file and the selected room component;
retrieving the digital file; and
storing, by the one or more processing devices, the digital file in association with the one or more room components.

12. The system of claim 11, wherein the instructions further comprise:
receiving, from a user device, a request to view the digital file; and
in response to the request to view the digital file, transmitting the digital file to the user device.

13. The system of claim 11 wherein the one of the one or more room components include one or more structures and/or one or more objects.

14. The system of claim 11 wherein the digital file is retrieved from a website or from the user device.

15. The system of claim 11 wherein the one or more room components are each selected from the group consisting of a piece of furniture, a bookcase, a file cabinet, a picture frame, entertainment element, and a piece of artwork.

16. The system of claim 11 wherein the virtual environment represents a house and the one or more rooms are located on floors within the house.

17. The system of claim 1 wherein the digital file is stored in a storage device remotely located from a user device.

18. The system of claim 17, wherein the instructions further comprise:
receiving, from the user device, a request to delete the association of the digital file; and
in response to the request to delete the digital file, deleting the digital file from the storage device.

19. The system of claim 11, wherein when the digital file is stored in association with the one or more room components, an indicator is provided which shows the one or more room components contain the digital file

20. A non-transitory computer-readable medium storing instructions, when executed by one or more processors, may cause the one or more processors to perform the steps of:
generating a virtual environment in a graphical user interface that comprises one or more rooms, each room including one or more room components therein;
receiving from a user device, a request to associate a digital file with a selected one of the one or more room components;
creating the association between the digital file and the selected room component;
retrieving the digital file; and
storing, by the one or more processing devices, the digital file in association with the one or more room component
